(19) United States
(12) Patent Application Publication
(10) Pub. No.: US 2015/0369589 A1
(43) Pub. Date: Dec. 24, 2015

(54) POSITIONAL SHIFT AMOUNT MEASUREMENT METHOD, CORRECTION TABLE GENERATION APPARATUS, IMAGING APPARATUS, AND PROJECTING APPARATUS

(71) Applicant: CANON KABUSHIKI KAISHA, Tokyo (JP)

(72) Inventor: Keiichiro Ishihara, Yokohama-shi (JP)

(21) Appl. No.: 14/738,077

(22) Filed: Jun. 12, 2015

(30) Foreign Application Priority Data
Jun. 20, 2014 (JP) 2014-127257
Apr. 27, 2015 (JP) 2015-090196

(51) Int. Cl. G01B 11/14; G01M 11/00

(52) U.S. Cl. CPC G01B 11/14; G01M 11/30

(57) ABSTRACT

A positional shift amount measurement method of measuring a positional shift amount of optical fibers in an optical fiber bundle formed by binding a plurality of optical fibers is provided. The positional shift amount measurement method includes: an image acquiring step of capturing an image of a test chart having a cyclic pattern in at least a first direction via the optical fiber bundle to acquire a captured image; a phase calculating step of calculating phases of respective pixels of the captured image from the cyclic pattern in the captured image; and a positional shift amount calculating step of calculating a pixel shift amount of the captured image resulting from a positional shift, in the first direction, of the optical fibers in units of sub pixels, based on a phase shift of pixels of the captured image arranged in a second direction vertical to the first direction.

### BACKGROUND OF THE INVENTION

1. Field of the Invention

The present invention relates to an image transmission system formed of an optical fiber bundle. More particularly, the present invention relates to an image transmission system suitable for reproducing a subject properly even when positional relation between an incident end surface and an exit end surface of an optical fiber bundle do not match. Further, the present invention relates to an imaging apparatus and a projecting apparatus using the same.

2. Description of the Related Art

Conventionally, an imaging apparatus is known, in which an image obtained by an imaging optical system is received on an incident end surface of an optical fiber bundle, and an image transmitted to an exit end surface of the optical fiber bundle is received by an image sensor such as a CCD or a CMOS to capture an image. Examples of such an imaging apparatus which uses an image transmission system include a digital still camera, a digital video camera, a mobile phone camera, a surveillance camera, a medical camera, a wearable camera, an infrared camera, an X-ray camera, and the like. Moreover, such an image transmission system can be used in an image projecting apparatus, and examples of the image projecting apparatus include a projector, a head-mounted display, and the like.

In the image transmission system formed of the optical fiber bundle, the image exiting from the exit end surface may be distorted unless positional relations of the respective optical fiber bundles on the incident end surface and the exit end surface of the optical fiber bundle match. Since high-accuracy manufacturing techniques are required for manufacturing the optical fiber bundle so that the positional relations of the respective optical fibers on the incident end surface and the exit end surface of the optical fiber bundle match, the manufacturing cost may increase considerably. As an inexpensive optical fiber bundle manufacturing method by which a satisfactory image can be obtained, there is a known method, in which an optical fiber bundle is manufactured such that positions of the respective optical fibers on the incident end surface and the exit end surface of the optical fiber bundle vary and then the positions of the respective optical fibers on the incident end surface and the exit end surface of the manufactured optical fiber bundle are aligned.

Japanese Patent No. 3091484 discloses a fiber bundle calibration method of generating a reference table for input-to-output pixels of a fiber bundle and obtaining an original image from the image generated on an output end of the fiber bundle using the reference table.

Japanese Patent Application Publication No. S60-217306 discloses an example of reproducing video signals reliably to obtain a high-resolution video image by matching positional relations including arrangements on both ends of an optical fiber bundle.

### SUMMARY OF THE INVENTION

According to the techniques disclosed in Japanese Patent No. 3091484 and Japanese Patent Application Publication No. S60-217306, when the optical fiber bundle, which is manufactured such that positions of the respective optical fibers on the incident end surface and the exit end surface of the optical fiber bundle vary, is used, positions of the incident end surface and the exit end surface of the respective optical fibers are aligned.

According to optical fiber bundle manufacturing techniques of the recent years, it is possible to manufacture an arrangement of optical fibers with high accuracy. Moreover, an optical fiber bundle in which the positional relations of respective optical fibers on the incident end surface and the exit end surface of the optical fiber bundle match substantially can be manufactured at a low cost. However, the optical fiber bundle manufacturing techniques of the recent years do not provide such manufacturing accuracy that the positional relations of the respective optical fibers on the incident end surface and the exit end surface match exactly. Thus, line segment-shaped distortion called shear distortion occurs in a plurality of positions.

An object of the present invention is to measure a positional shift amount in respective optical fibers on an incident end surface and an exit end surface, resulting from shear distortion or the like with high accuracy.

According to a first aspect of the present invention, there is provided

a positional shift amount measurement method of measuring a positional shift amount of optical fibers in an optical fiber bundle formed by binding a plurality of optical fibers, the method including:

an image acquiring step of capturing an image of a test chart having a cyclic pattern in at least a first direction via the optical fiber bundle to acquire a captured image;

a phase calculating step of calculating phases of respective pixels of the captured image from the cyclic pattern in the captured image; and

a positional shift amount calculating step of calculating a pixel shift amount of the captured image resulting from a positional shift, in the first direction, of the optical fibers in units of sub pixels on the basis of a phase shift of pixels of the captured image arranged in a second direction vertical to the first direction.

According to a second aspect of the present invention, there is provided

a correction table generation apparatus that generates a correction table used for correcting an image captured by an imaging apparatus that captures an image via an optical fiber bundle configured by binding a plurality of optical fibers, the correction table generation apparatus including:

an image acquisition unit that acquires a captured image of a test chart having a cyclic pattern in at least a first direction, captured via the optical fiber bundle;

a phase calculation unit that calculates phases of respective pixels of the captured image from the cyclic pattern in the captured image;

a positional shift amount calculation unit that calculates a pixel shift amount of the captured image resulting from a positional shift, in the first direction, of the optical fibers in units of sub pixels on the basis of a phase shift of pixels of the captured image arranged in a second direction vertical to the first direction; and

a table generation unit that generates a correction table used for correcting images, and stores for each target pixel coordinates of a plurality of reference pixels determined based on the pixel shift amount and correction coefficients of the respective reference pixels.

According to a third aspect of the present invention, there is provided

an imaging apparatus including an imaging optical system, an optical fiber bundle, an image sensor, a storage unit, and a processing unit,

the imaging optical system forming an image of a subject on an incident end surface of the optical fiber bundle, and

the image sensor acquiring an image exiting from an exit end surface after being transmitted through the optical fiber bundle and storing the image in the storage unit, wherein

the optical fiber bundle has a structure which is obtained by binding a plurality of multi-fibers each obtained by binding a plurality of optical fibers or a structure which is obtained by binding a plurality of multi-multi fibers each obtained by binding a plurality of multi-fibers, and in which a relative positional relation between the incident end surface and the exit end surface, of part or all of the multi-fibers or the multi-multi fibers varies in comparison with surrounding optical fibers, and a pixel shift occurs between the image received on the incident end surface of the optical fiber bundle and the image transmitted to the exit end surface,

the storage unit stores a correction table for correcting the pixel shift, and

the processing unit performs a correction process on the image obtained from the image sensor, using the correction table.

According to a fourth aspect of the present invention, there is provided

a projecting apparatus including a spatial modulator, an optical fiber bundle, a projection optical system, a storage unit, and a processing unit,

the spatial modulator displaying an image corresponding to an input signal and projecting the image on an incident end surface of the optical fiber bundle, and

the projection optical system projecting an image exiting from an exit end surface after being transmitted through the optical fiber bundle, wherein

the optical fiber bundle has a structure which is obtained by binding a plurality of multi-fibers each obtained by binding a plurality of optical fibers or a structure which is obtained by binding a plurality of multi-multi fibers each obtained by binding a plurality of multi-fibers, in which a relative positional relation between the incident end surface and the exit end surface, of some or all of the multi-fibers or the multi-multi fibers in relation to surrounding optical fibers varies, and a pixel shift occurs between the image received on the incident end surface of the optical fiber bundle and the image transmitted to the exit end surface,

the storage unit stores a correction table for correcting the pixel shift,

the processing unit performs a correction process on the image obtained from the input signal using the correction table, and

the spatial modulator displays the image corrected by the processing unit.

According to the present invention, a positional shift amount of some optical fibers resulting from shear distortion or the like occurring in an optical fiber bundle can be measured with high accuracy.

Further features of the present invention will become apparent from the following description of exemplary embodiments with reference to the attached drawings.

### BRIEF DESCRIPTION OF THE DRAWINGS

FIG. 1 is a diagram illustrating a configuration of an imaging apparatus according to Embodiment 1;

FIGS. 2A and 2B are diagrams illustrating a configuration of an optical fiber bundle;

FIGS. 3A to 3D are diagrams for describing the causes of shear distortion;

FIGS. 4A to 4D are diagrams for describing a test chart measuring process and shear distortion;

FIGS. 5A and 5B are diagrams illustrating a captured image after size-reduction;

FIGS. 6A to 6C are diagrams for describing a phase and a phase difference;

FIG. 7 is a flowchart of a positional shift amount calculation method of Embodiment 1;

FIGS. 8A and 8B are flowcharts of a pixel arrangement conversion table generating method of Embodiment 1;

FIG. 9 is a flowchart of a pixel arrangement correction image generating method of Embodiment 1;

FIG. 10 is a diagram illustrating a test chart used in Embodiment 2;

FIG. 11 is a diagram illustrating a test chart used in Embodiment 3;

FIG. 12 is a diagram illustrating a test chart used in Embodiment 4;

FIG. 13 is a diagram illustrating a configuration of an imaging apparatus according to Embodiment 5;

FIG. 14 is a diagram for describing a correction coefficient calculating method;

FIG. 15 is a diagram illustrating a configuration of an imaging apparatus according to Embodiment 6;

FIG. 16 is a diagram illustrating a configuration of a projecting apparatus according to Embodiment 7;

FIG. 17 is a diagram illustrating the steps of manufacturing an optical fiber bundle according to Embodiment 8;

FIG. 18 is an enlarged view of a boundary between multi-multi fibers used in Embodiment 8; and

FIG. 19 is a flowchart of an optical fiber bundle manufacturing method according to Embodiment 8.

### DESCRIPTION OF THE EMBODIMENTS

### Embodiment 1

### Configuration

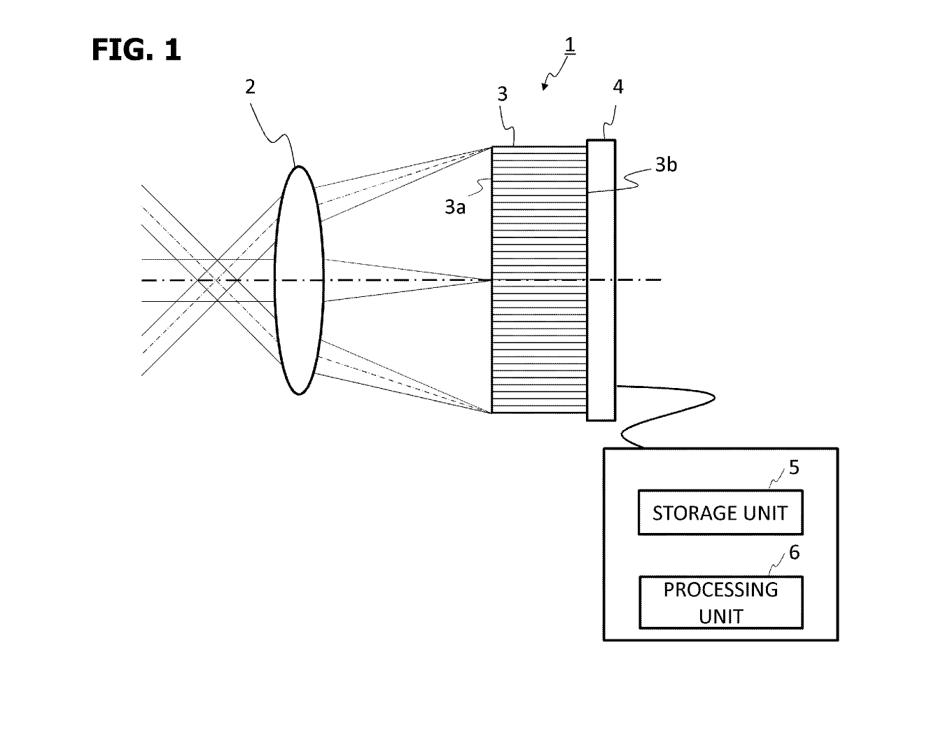

An imaging apparatus according to Embodiment 1 of the present invention will be described. FIG. 1 illustrates an imaging apparatus according to the present embodiment. An imaging apparatus 1 includes an imaging optical system 2, an optical fiber bundle 3 which is an image transmission unit, an image sensor 4, a storage unit 5, and a processing unit 6.

The imaging optical system 2 images a subject present on a focusing plane (not illustrated) onto a planar image plane to obtain a subject image. The optical fiber bundle 3 has a planar incident end surface 3a and a planar exit end surface 3b. The imaging optical system 2 images the subject image onto the incident end surface 3a of the optical fiber bundle 3. The optical fiber bundle 3 transmits the subject image received on the incident end surface 3a to the exit end surface 3b. The image sensor 4 is disposed in close contact with the exit end surface 3b of the optical fiber bundle so as to acquire the image transmitted to the exit end surface 3b of the optical fiber bundle. The image data acquired by the image sensor 4 is subjected to predetermined image processing in the processing unit 6 and the processed image data is stored in the storage unit 5. The imaging apparatus 1 of the present embodiment performs imaging in this manner. The processing unit 6 is formed of an arithmetic processing apparatus such as a microprocessor and executes various processes by executing a program. Some or all parts of the processing unit 6 may be configured as a dedicated hardware circuit. The storage unit 5 is a nonvolatile memory and is typically a semiconductor memory such as a flash memory.

When the imaging apparatus 1 is an infrared camera, a fluorescent member that emits visible light when infrared rays are received on the incident end surface 3a of the optical fiber bundle may be applied to the incident end surface. Because of this, the imaging apparatus 1 can perform imaging with high sensitivity in a wavelength range in which the image sensor 4 has low or zero sensitivity.

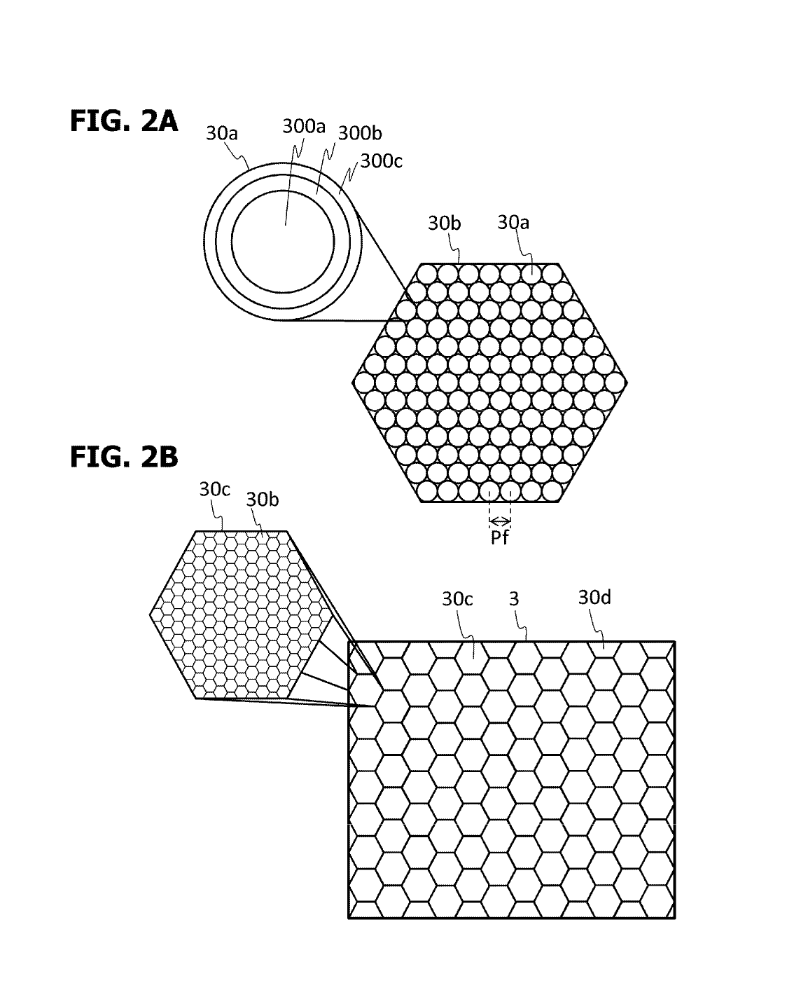

The optical fiber bundle 3 used in the imaging apparatus 1 of the present embodiment will be described with reference to FIGS. 2A and 2B. FIG. 2A is a cross-sectional view illustrating a configuration of a multi-fiber 30b obtained by binding a plurality of optical fibers. FIG. 2B is a cross-sectional view illustrating a configuration of the optical fiber bundle 3 obtained by binding a plurality of multi-multi fibers each being obtained by binding a plurality of multi-fibers.

The multi-fiber 30b illustrated in FIG. 2A includes a plurality of optical fibers 30a. The respective optical fibers 30a have a three-layer structure including a core layer 300a, a cladding layer 300b, and a light absorbing layer 300c disposed in that order from the inner side. The optical fiber 30a has a diameter of 3 μm. The plurality of optical fibers 30a are arranged without any gap to form the multi-fiber 30b. In this case, the optical fibers 30a are arranged in a hexagonal lattice form with a fiber pitch Pf of 3 μm, whereby the multi-fiber 30b has an approximately hexagonal shape. The fiber pitch is a center-to-center distance of two adjacent fibers.

Light entering the incident end surface of the core layer 300a propagates through the core layer 300a to reach the exit end surface of the core layer 300a while experiencing total reflection at the boundary surface between the core layer 300a and the cladding layer 300b. On the other hand, light leaking from the core layer 300a is absorbed by the light absorbing layer 300c and does not reach the exit end surface. In this manner, the respective optical fibers 30a transmit light (that is, an image for the optical fiber bundle 3) entering the incident end surface to the exit end surface by allowing light entering the incident end surface to propagate toward the exit end surface.

FIG. 2B illustrates a configuration of the optical fiber bundle 3. The optical fiber bundle 3 includes a plurality of multi-multi fibers 30c and 30d. The multi-multi fiber 30c is obtained by binding the plurality of multi-fibers 30b illustrated in FIG. 2A and arranging the multi-fibers in a hexagonal lattice form. The multi-multi fiber 30c has an approximately hexagonal shape. The multi-multi fiber 30d is also obtained by binding and arranging the plurality of multi-fibers 30b and has an approximately trapezoidal shape. The optical fiber bundle 3 is formed by binding the plurality of multi-multi fibers 30c and arranging the multi-multi fibers without any gap. Moreover, the multi-multi fibers 30d having an approximately trapezoidal shape are disposed in the peripheral portion of the optical fiber bundle 3 to form the approximately rectangular optical fiber bundle 3.

The optical fiber bundle 3 of the present embodiment is not obtained by binding the optical fibers 30a together, but a plurality of cluster blocks obtained by binding the optical fibers 30a are arranged to form the final optical fiber bundle 3. In the present embodiment, three levels of blocks are used such that the optical fibers 30a are bound together to form the multi-fiber 30b and the multi-fibers 30b are further bound together to form the multi-multi fiber 30c, and the multi-multi fibers 30c are bound together to form the optical fiber bundle 3. However, the optical fiber bundle 3 may be formed using two, four, or more levels of blocks.

(Causes of Shear Distortion)

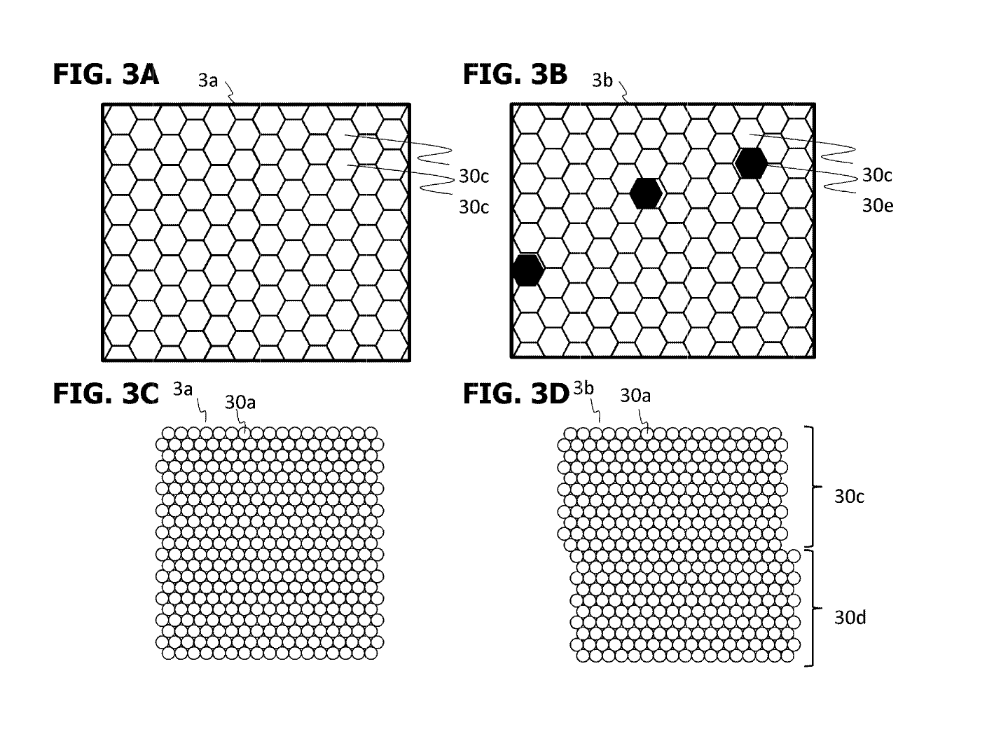

Next, the causes of shear distortion will be described with reference to FIGS. 3A and 3B. FIG. 3A illustrates an example of the incident end surface 3a of the optical fiber bundle and FIG. 3B illustrates an example of the exit end surface 3b of the optical fiber bundle.

In the example of FIG. 3A, the multi-multi fibers 30c in the incident end surface 3a of the optical fiber bundle are arranged coherently. On the other hand, in the example of FIG. 3B, a large number of multi-multi fibers 30c in the exit end surface 3b of the optical fiber bundle are arranged coherently whereas some multi-multi fibers 30e cause a positional shift. In FIG. 3B, the multi-multi fibers 30e that cause a positional shift are displayed black.

Shear distortion occurs, for example, when the multi-multi fibers 30e in the exit end surface 3b cause a positional shift and the arrangement of the multi-multi fibers 30e in the exit end surface 3b is different from the arrangement of the multi-multi fibers 30c in the incident end surface 3a.

FIG. 3C illustrates an enlarged view of the boundary portion between the multi-multi fibers 30c in the incident end surface 3a of the optical fiber bundle 3 of FIG. 3A. FIG. 3D illustrates an enlarged view of the boundary portion between the multi-multi fibers 30c and 30e in the exit end surface 3b of the optical fiber bundle 3 of FIG. 3B.

As illustrated in FIG. 3C, when a portion of the optical fiber bundle 3 is viewed at an enlarged scale, the optical fibers 30a are visible, and the optical fibers 30a are arranged coherently in the incident end surface 3a of the optical fiber bundle.

On the other hand, as illustrated in FIG. 3D, a positional shift occurs in a portion of the exit end surface 3b of the optical fiber bundle. A positional shift does not occur in the optical fibers 30a that belong to the multi-multi fibers 30c in which no positional shift occurs. However, a positional shift occurs in the optical fibers 30a that belong to the multi-multi fibers 30e in which a positional shift occurs.

As described above, when a positional shift occurs in the relative positional relation between the incident end surface and the exit end surface, of some multi-multi fibers in the optical fiber bundle as compared to the surrounding multi-multi fibers, the same positional shift occurs in the optical fibers 30a that belong to the multi-multi fibers. This may cause shear distortion.

Although a case in which the multi-multi fibers 30e in the exit end surface 3b cause a positional shift has been described, the causes of shear distortion are not limited thereto.

For example, shear distortion occurs similarly when the multi-multi fibers 30c in the incident end surface 3a cause a positional shift. That is, shear distortion also occurs when the arrangement of the multi-multi fibers 30c in the incident end surface 3a is different from the arrangement of the multi-multi fibers in the exit end surface 3b.

Further, shear distortion occurs similarly when the multi-fibers 30b rather than the multi-multi fibers 30c, in either the incident end surface 3a or the exit end surface 3b cause a positional shift.

(Shear Distortion Amount Measuring Method)

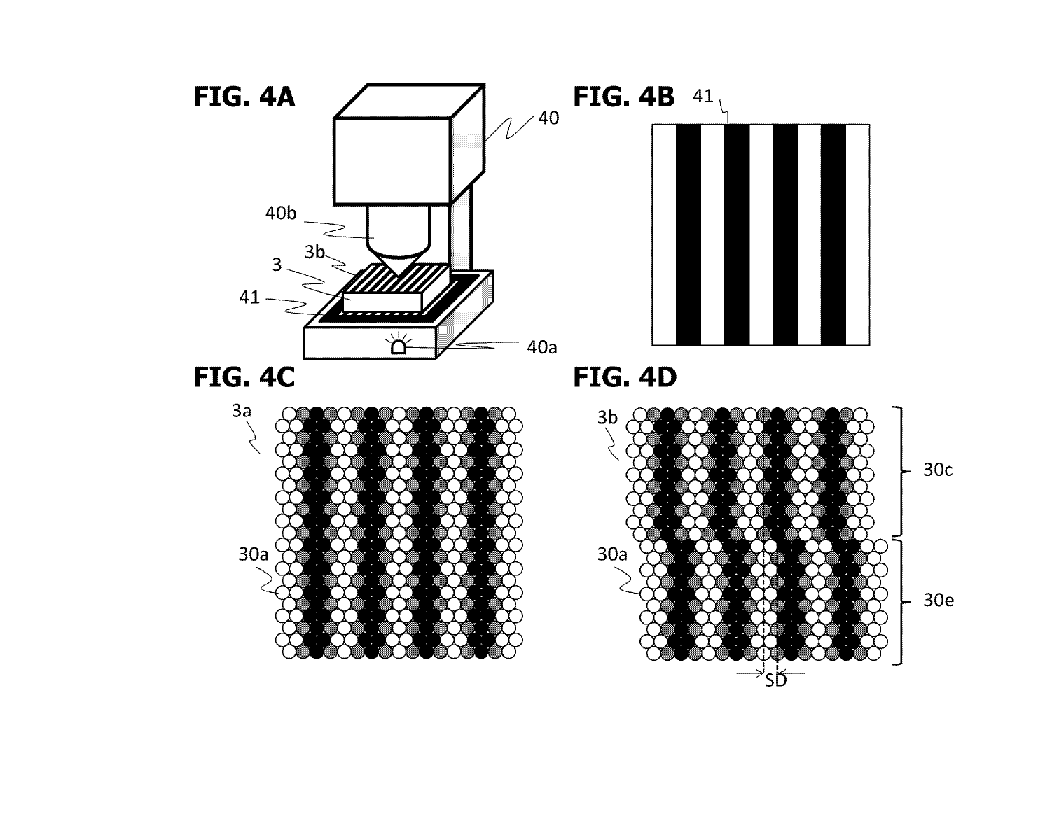

A shear distortion amount measuring method will be described with reference to FIGS. 4A to 4C. FIG. 4A illustrates an optical microscope, FIG. 4B illustrates a test chart, FIG. 4C illustrates an image acquired on an incident end surface of an optical fiber bundle, and FIG. 4D illustrates a transmission image on an exit end surface of an optical fiber bundle.

FIG. 4A illustrates how an image transmitted by the optical fiber bundle 3 is observed using an optical microscope 40. A test chart 41 is set on the optical microscope 40, and the optical fiber bundle 3 is disposed on the test chart 41 with the incident end surface 3a facing downward. An illumination source 40a illuminates the test chart 41 from the rear side. An image of the test chart 41 entering the incident end surface 3a of the optical fiber bundle 3 is transmitted to the exit end surface 3b, and the transmission image displayed on the exit end surface 3b is captured by the optical microscope 40 using an objective lens 40b having a magnification of 20.

FIG. 4B illustrates the test chart 41 having a cyclic pattern. The test chart 41 is a vertical stripe chart having a cyclic pattern in the horizontal direction. This cyclic pattern is a rectangular pattern having two values of high and low transmittance (the colors white and black) and has a spatial frequency of 83.3 pairs/mm (Line Pairs/mm). The spatial frequency of 83.3 pairs/mm corresponds to a cycle of 12.0 μm. Since the fiber pitch Pf of the optical fiber bundles of the present embodiment is 3 μm, the test chart 41 has a cycle of 4.00 times the fiber pitch. A positional shift amount that can be detected is ±half the cycle of the test chart 41. Thus, according to the above configuration, it is possible to detect a positional shift amount of up to ±2.00 times the fiber pitch.

The cycle Tc of the cyclic pattern may be set so as to satisfy the relation of Expression (1) below in relation to the fiber pitch Pf. A detection range becomes too narrow if Tc/Pf is smaller than the lower limit of Expression (1) and detection accuracy decreases if Tc/Pf is larger than the upper limit. Under the condition of Expression (1), the detection range and the detection accuracy are well-balanced.

2≦Tc/Pf≦20 (1)

FIG. 4C illustrates an image acquired on the incident end surface 3a of the optical fiber bundle 3 (that is, FIG. 4C displays the image of the test chart 41 received on the incident end surface 3a). The light entering the respective optical fibers 30a is averaged and the rectangular pattern of the test chart of FIG. 4B is converted to a light quantity distribution of the respective optical fibers 30a of FIG. 4C.

FIG. 4D illustrates a transmission image on the exit end surface 3b of the optical fiber bundle 3 (that is, FIG. 4D illustrates the image transmitted from the incident end surface 3a to the exit end surface 3b). When shear distortion is not present in the optical fiber bundle 3, the image transmitted to the exit end surface 3b is the same as the image of FIG. 4C. However, the image of FIG. 4D is different from the image of FIG. 4C due to shear distortion. Here, a positional shift does not occur in the optical fibers 30a that belong to the multi-multi fiber 30c in which a positional shift is not present. Thus, in regions corresponding to the multi-multi fibers 30c, the transmission image of FIG. 4D is the same as the acquired image of FIG. 4C. However, a positional shift occurs in the optical fibers 30a that belong to the multi-multi fiber 30e in which a positional shift is present. Thus, in regions corresponding to the multi-multi fibers 30e, a positional shift from a desired position occurs between the transmission image of FIG. 4D and the acquired image of FIG. 4C. In this case, a positional shift amount from the optical fiber 30a in which a positional shift does not occur to the optical fiber 30a in which a positional shift occurs is defined as a shear distortion amount SD. In this example, a positional shift amount from a boundary between the black and white lines on the optical fiber 30a in which a positional shift does not occur to a boundary between the black and white lines on the optical fiber 30a in which a positional shift occurs is defined as the shear distortion amount SD.

A pixel pitch of an image (microscope image) captured by the microscope 40 using the 20× objective lens 40b is approximately ⅙ of the fiber pitch on the image and is sufficiently small, and the outline of the optical fiber 30a and the gaps formed between the plurality of optical fibers 30a can be expressed clearly. However, such a high-definition image is not suitable for measuring the positional shift amount of the present embodiment.

On the other hand, if the microscope image is reduced at the ratio of ⅙ so that the pixel pitch is approximately the same as the fiber pitch on the image, it is difficult to observe the outline of the optical fiber 30a and the gaps formed between the plurality of optical fibers 30a, but only the cyclic pattern of the test chart 41 is displayed.

In the present embodiment, the positional shift amount of the lines of the cyclic pattern is measured using an image having approximately the same pixel pitch as the fiber pitch on the image to measure the shear distortion amount occurring in the optical fiber bundle.

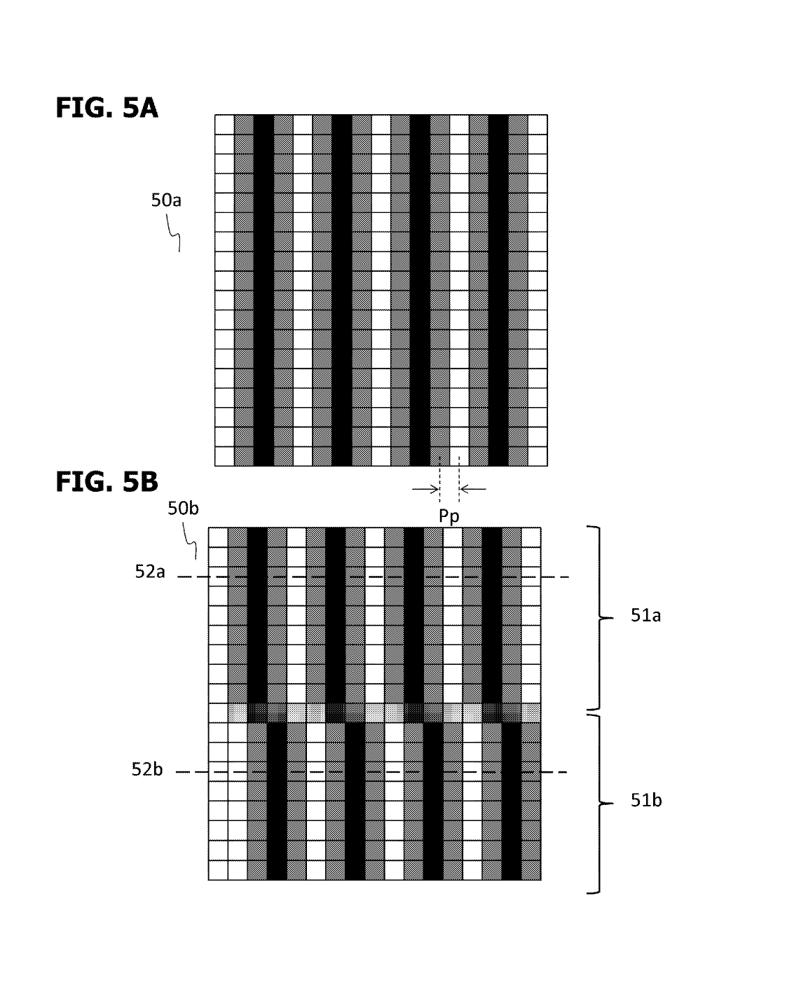

FIG. 5A illustrates a reduced image of the image received on the incident end surface 3a of the optical fiber bundle 3 or a reduced image 50a of the image transmitted to the exit end surface 3b when shear distortion is not present in the optical fiber bundle 3. FIG. 5B illustrates a reduced image 50b of the image transmitted to the exit end surface 3b when shear distortion is present in the optical fiber bundle 3.

FIG. 5A illustrates a reduced image obtained by reducing the acquired image on the incident end surface 3a of the optical fiber bundle 3 illustrated in FIG. 4C at the ratio of ⅙ so that the pixel pitch is approximately the same as the fiber pitch on the image.

In the present embodiment, an image is acquired using a 20× objective lens and the captured image is reduced so that each optical fiber in the optical fiber bundle corresponds to one pixel. However, an image may be captured under such conditions according to which the captured image is obtained by the microscope 40 so that each optical fiber in the optical fiber bundle correspond to one pixel. That is, an image may be captured by the microscope 40 using a low-magnification objective lens so that the pixel pitch is approximately the same as the fiber pitch on the image. When the microscope 40 of the present embodiment is used, an optimal magnification of the objective lens is 3.3. However, since objective lens magnification scales are limited, if an image is reduced after capturing the image using a high-magnification objective lens, the limitation on lens magnification scales can be avoided. Instead of acquiring the image of the test chart using an apparatus such as the microscope 40 other than an imaging apparatus on which the optical fiber bundle 3 is mounted, the following processing may be performed using the image of the test chart captured by an imaging apparatus on which the optical fiber bundle 3 is mounted.

The pixel pitch Pp of an image used for measurement may satisfy the relation of Expression (2) in relation to the fiber pitch Pf on the image. If Pp/Pf is smaller than the lower limit of Expression (2), detection accuracy becomes too high and a structure other than the cyclic pattern such as the gaps between optical fibers may appear. On the other hand, if Pp/Pf is larger than the upper limit of Expression (2), detection accuracy may decrease.

0.3<Pp/Pf<3 (2)

When a 5× objective lens is used, the pixel pitch Pp is 0.66 times the fiber pitch Pf on the image and the condition of Expression (2) is satisfied. Thus, the image captured by the microscope 40 using a 5× objective lens may be used for measurement.

Moreover, the image 50b illustrated in FIG. 5B is a reduced image obtained by reducing the transmission image on the exit end surface 3b of the optical fiber bundle 3 illustrated in FIG. 4D at the ratio of ⅙ so that the pixel pitch is approximately the same as the fiber pitch on the image. In the following description, the shear distortion amount is measured using this reduced image. The image (reduced image) used for measurement of the shear distortion amount is also referred to as a measurement image.

The image of FIG. 5B includes a pixel region 51a in which a positional shift is not present and a pixel region 51b in which shear distortion occurs and a positional shift is present. Representative rows of the pixel regions 51a and 51b will be referred to as pixel rows 52a and 52b, respectively.

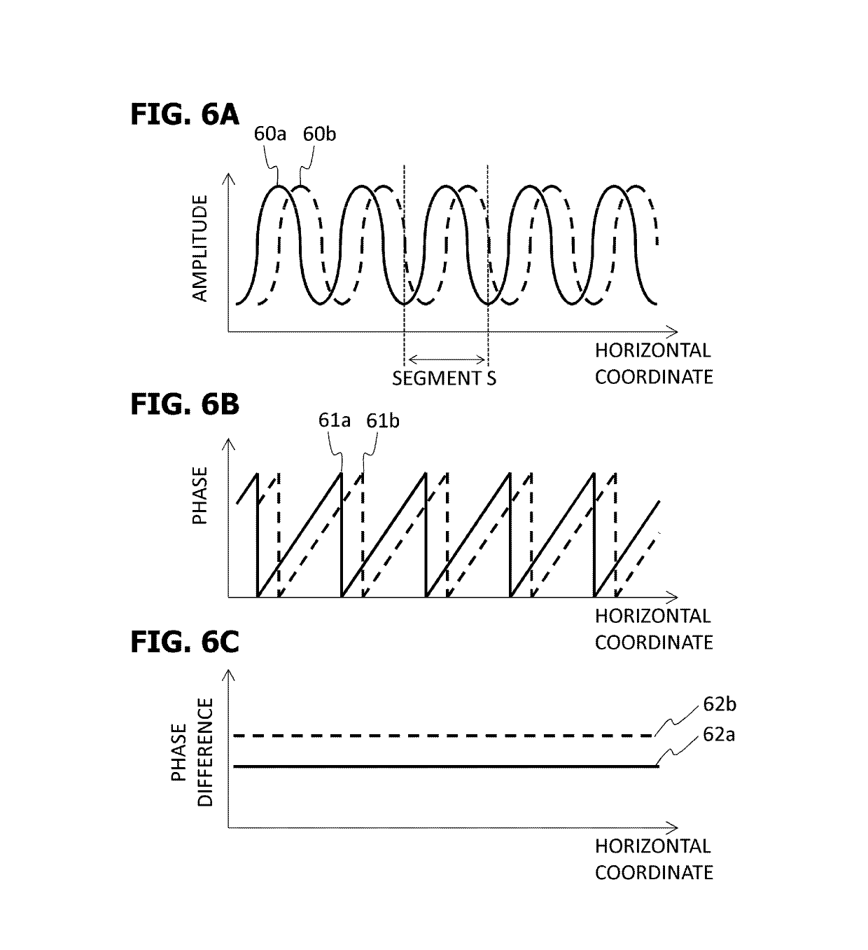

FIG. 6A illustrates a waveform of the cyclic pattern, FIG. 6B illustrates the phase of the cyclic pattern, and FIG. 6C illustrates a phase difference of the cyclic pattern.

In FIG. 6A, a waveform 60a of the cyclic pattern in the pixel row 52a of the image 50b illustrated in FIG. 5B is depicted by a solid line, and a waveform 60b of the cyclic pattern in the pixel row 52b of the image 50b illustrated in FIG. 5B is depicted by a broken line. Although the cyclic pattern of the test chart is a rectangular pattern, the image of the cyclic pattern is replaced with a waveform when the image is converted to a measurement image of which the pixel pitch is approximately the same as the fiber pitch on the image.

In FIG. 6B, a phase 61a of the waveform 60a illustrated in FIG. 6A is depicted by a solid line, and a phase 61b of the waveform 60b is depicted by a broken line. If the captured image of the cyclic pattern can be replaced with a waveform, the horizontal coordinate and the phase of the respective waveforms can be correlated.

A method of setting a reference phase and a reference cycle will be described. In the present embodiment, a segment S of the waveform 60a of FIG. 6A is used as a reference region, a relation between the horizontal coordinate and the phase in the reference region is calculated, and a reference phase in all horizontal coordinates is set based on the calculated relation. Moreover, a reference cycle is calculated from the reference region and the reference cycle of the present embodiment is 4.0 pixels. The pixel used as the unit is the pixel pitch of an image.

Next, a phase difference calculating method will be described. FIG. 6C illustrates a phase difference from a reference phase. Phase differences 62a and 62b illustrated in FIG. 6C are calculated by subtracting a reference phase from the phases 61a and 61b illustrated in FIG. 6B. That is, a difference between the phase of a target pixel for calculation of the phase difference and the phase (reference phase) in a reference region having the same horizontal position as the target pixel is calculated as a phase difference of the target pixel. In the present embodiment, the reference phase is the same as the phase 61a illustrated in FIG. 6B and the phase difference 62a calculated by subtracting the reference phase from the phase 61a is zero in any horizontal position. The phase difference 62b calculated by subtracting the reference phase from the phase 61b is +π/2 in any horizontal position.

The phase differences 62a and 62b illustrated in FIG. 6C are values representing only the positional shift amount of the cyclic pattern in which a phase component varying depending on a horizontal coordinate component is removed. Thus, a positional shift amount (that is, the shear distortion amount) of the optical fiber bundle 3 of the present embodiment is +π/2. Moreover, since the reference cycle is 4.0 pixels, when the phase difference is converted to a positional shift amount in pixel unit, it can be understood that a pixel-based positional shift amount (shear distortion amount) is +1.0 pixel.

In this manner, by calculating the phase from the captured image of the cyclic pattern, the pixel-based positional shift amount (shear distortion amount) can be measured. In the above example, although the pixel-based positional shift amount is an integer, the pixel-based positional shift amount is calculated in units of decimal points depending on the values of the reference cycle and the phase difference. That is, the pixel-based positional shift amount (shear distortion amount) can be calculated with high accuracy in units of sub pixels.

In the present invention, shear distortion occurs in respective blocks of multi-fibers and multi-multi fibers, which is greatly different from the conventional example in which positional relations of respective optical fibers on the incident end surface and the exit end surface vary.

This difference also appears in the aspect of a positional shift. In the case of a positional shift caused by shear distortion, although discontinuous points of the cyclic pattern appear at the boundary between blocks such as multi-fibers and multi-multi fibers, the continuity of the cyclic pattern is maintained on the outer side and the inner side of the block. That is, a relative positional relation between adjacent optical fibers collapses in the boundary between blocks only, and the relative positional relation is maintained properly on the outer side and the inner side of the block. Therefore, by calculating the phase from the cyclic pattern, the relative positional relation can be detected with high accuracy in units of sub pixels if the positional shift is within ±½ cycle. Moreover, when the phase difference from the reference region is used, an absolute positional relation can be detected with high accuracy in units of sub pixels.

On the other hand, when the positional relation of the respective optical fibers varies from incident end surface to exit end surface as in the conventional example, since the relative positional relation between adjacent optical fibers collapses in all surfaces, it is not possible to calculate the phase from the cyclic pattern.

(Process Flow)

The pixel-based positional shift amount measuring process may be executed by a measuring apparatus which is a computer having a central processing unit (CPU), a memory, and the like. When the CPU executes application programs stored in the memory, the measuring apparatus can execute the following processes. Some or all of the processes may be performed by a dedicated hardware circuit.

((Pixel-Based Positional Shift Amount Measuring Process))

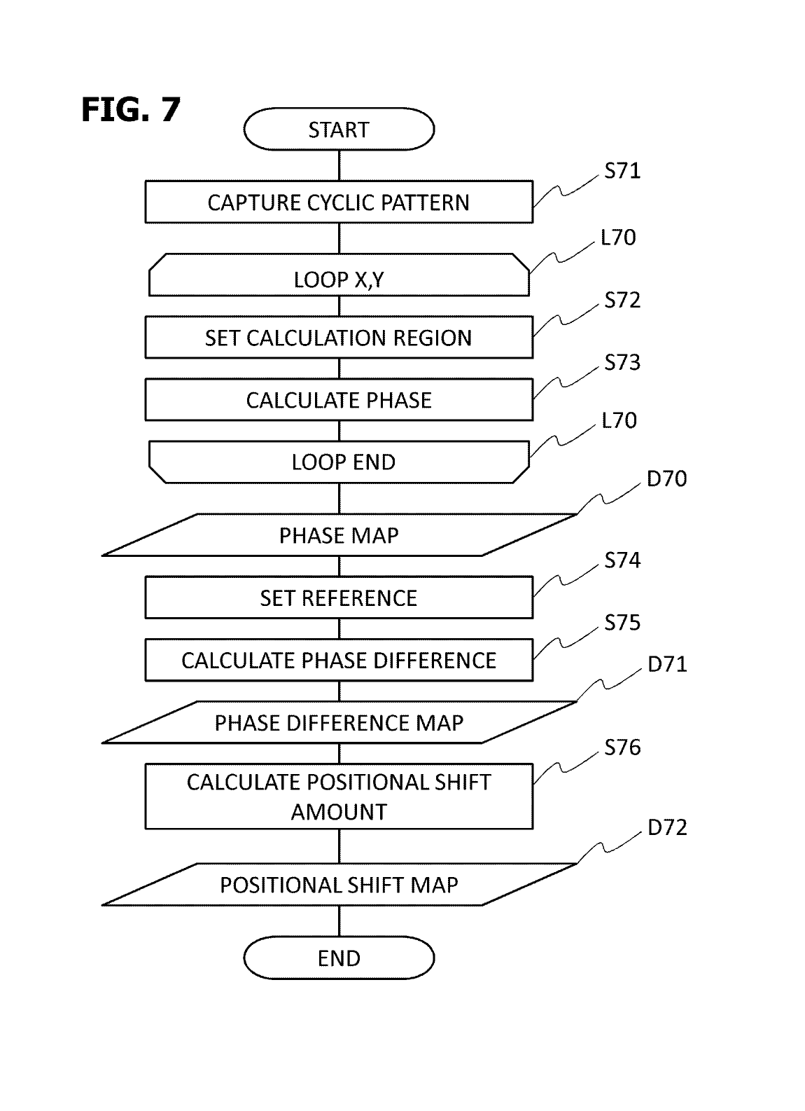

A pixel-based positional shift amount (that is, the shear distortion amount) measuring method will be described with reference to FIG. 7. FIG. 7 illustrates a flowchart of a pixel-based positional shift amount (shear distortion amount) measuring process executed by a measuring apparatus (computer).

First, in a cyclic pattern capturing step (step S71), the measuring apparatus acquires an image of a test chart, captured via the optical fiber bundle 3. The image of the test chart is captured by placing a test chart of a vertical stripe cyclic pattern having a cycle of 4 times the fiber pitch in the horizontal direction in close contact with an optical fiber bundle as illustrated in FIG. 4A and capturing the transmission image appearing on the exit end surface while propagating through the optical fiber bundle using the microscope 40. A method of importing the captured image captured by the microscope 40 into the measuring apparatus is optional.

Subsequently, the flow proceeds to loop L70 for calculating the phase from the captured image. Loop L70 is performed for a target pixel for calculation of the phase and is typically executed for all pixels excluding a peripheral portion (a region corresponding to several pixels from an end) of the captured image.

In a calculation region setting step (step S72), a region used for the phase calculation is set for the target pixel for the phase calculation. Specifically, a region corresponding to five pixels in the horizontal direction which are two pixels (pixels of approximately half the cycle) each on the left and right sides of the target pixel is set as a calculation region for the phase calculation. A pixel region that is approximately the same as the cycle is set as the calculation region, and the phase can be calculated with high accuracy and high horizontal resolution.

In a phase calculation step (step S73), the phase of the target pixel is calculated from the calculation region. Specifically, first, Fourier transform is performed in the calculation region to convert the image into spatial frequency information. Subsequently, a DC component is removed and the phase of a spatial frequency component of which the spatial frequency information has the largest amplitude is calculated. The phase can be calculated from an angle between the real part and the imaginary part of the spatial frequency component. In this manner, position information can be acquired with high accuracy in units of sub pixels by calculating the pixel-based positional shift amount using the phase of the cyclic pattern. Moreover, by calculating the phase from the spatial frequency component having the largest amplitude in the respective calculation regions, even when the pitches of the cyclic pattern are different, since the phase is detected based on the spatial frequency components corresponding to the different pitches, it is possible to calculate the position information with high robustness.

In loop L70, all pixels excluding the peripheral portion of the captured image are used as the target pixels for calculation of the positional shift amount, and the positional shift amount is calculated repeatedly by scanning the target pixels sequentially in the vertical direction X and the horizontal direction Y. In this way, a phase map (data D70) in which respective pixels are correlated with the corresponding phases is created.

Subsequently, in a reference setting step (step S74), a portion of the captured image is set as a reference region, and the cycle and the phase are calculated from the reference region and are set as the reference cycle and the reference phase. Specifically, Fourier transform is performed in the reference region to convert the image into spatial frequency information. Subsequently, a DC component is removed and a spatial frequency component of which the spatial frequency information has the largest amplitude is used as a reference frequency, and a reciprocal of the reference frequency is calculated as a cycle and is set as the reference cycle. Moreover, a relation between the coordinate and the phase is acquired from a position of the phase map corresponding to the reference region and is set as the reference phase.

The size of the reference region is not particularly limited. The upper limit of the horizontal size of the reference region is the number of pixels corresponding to the width of an end surface of the optical fiber bundle and the lower limit is the number of pixels (in this example, 4 pixels) corresponding to one cycle of the test chart. The upper limit of the vertical size of the reference region is the number of pixels corresponding to the width of an end surface of the optical fiber bundle and the lower limit is 3 pixels. When the size of the reference region satisfies the above conditions, it is possible to calculate the reference cycle and the reference phase accurately.

A region in which shear distortion does not occur may preferably set as the reference region. The region in which shear distortion does not occur can be obtained as a region in which the percentage of pixels of which the phases calculated in the phase calculating step are regular is high. The reference region may be set by the measuring apparatus and may be set by a user. When the reference region is the entire end surface of the optical fiber bundle or the entire captured image, the reference region is preferably set by the measuring apparatus automatically. When the reference region is a portion of the captured image, the reference region is preferably set by the user.

When the reference region is set to a partial horizontal coordinate of the captured image, the reference phase for all horizontal coordinates can be calculated by expanding the reference phase calculated for the reference region. That is, since a sinusoidal wave calculated from the reference cycle and the reference phase calculated from the reference region continuously appears in regions other than the reference region, it is possible to calculate the reference phase for the respective pixels outside the reference region.

Subsequently, in a phase difference calculating step (step S75), a phase difference of respective pixels in relation to the reference region is calculated. The calculation results may be displayed as a phase difference map (data D71). Specifically, a phase difference is calculated by subtracting the reference phase at which a coordinate corresponds to a phase from the phases of the respective pixels represented by a phase map. Although the phase changes with the horizontal coordinate in the phase map, the phase difference map can eliminate a change in the phase difference with the coordinate. Moreover, when a vertical stripe of the cyclic pattern is slightly inclined, although the phase changes with the vertical coordinate in the phase map, the phase difference map eliminates this problem. In this manner, in the phase difference calculating step (step S75), by using the phase map (data D71) and the reference phase, it is possible to calculate the positional shift amount from the reference phase, of the respective pixels in units of phases.

Subsequently, in a positional shift amount calculating step (step S76), a positional shift amount of the respective pixel is calculated in units of sub pixels. Specifically, the phase difference is converted to a positional shift amount in a sub pixel-based positional shift amount by multiplying the phase difference map (data D71) by the reference cycle. Moreover, a positional shift map (data D72) that maps the sub pixel-based positional shift amount of the respective pixels is generated and output.

As described above, by using a pixel-based positional shift amount measurement method of the present embodiment, it is possible to detect a pixel-based positional shift in the horizontal direction in respective blocks occurring due to shear distortion or the like with high accuracy in units of sub pixels.

In the above description, although Fourier transform is employed to calculate the phase, an optional method may be used as long as the phase can be calculated. For example, the phase may be calculated using a template matching method. That is, the same image as the image (test chart) input to the optical fiber bundle 3 may be prepared as a reference image, a correlation with the transmission image may be calculated while sequentially shifting the reference image by one pixel, and a position at which a highest correlation is obtained may be determined. In this way, the phase can be calculated based on the position.

((Pixel Arrangement Conversion Table Generating Process))

If it is possible to know a positional shift (pixel-based positional shift) occurring due to transmission through the optical fiber bundle 3, it is possible to generate a correction table used for a correction process for removing the positional shift from the captured image acquired after transmission through the optical fiber bundle 3. In the following description, this correction table is also referred to as a pixel arrangement conversion table.

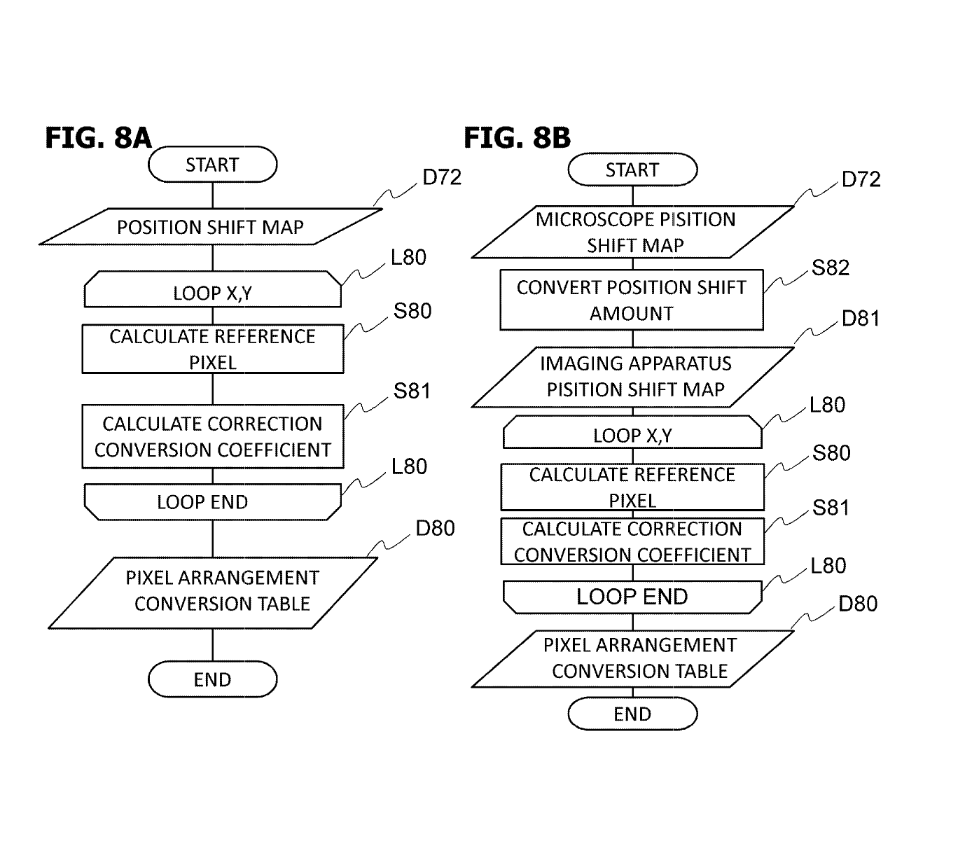

Hereinafter, a pixel arrangement conversion table generating process will be described with reference to FIG. 8A. FIG. 8A illustrates a flowchart of a pixel arrangement conversion table generating process executed by the measuring apparatus (computer). The pixel-based positional shift amount measuring process and the pixel arrangement conversion table generating process are performed by the same apparatus (the measuring apparatus), and the measuring apparatus corresponds to a correction table generation apparatus. The pixel-based positional shift amount measuring process and the pixel arrangement conversion table generating process may be executed by a plurality of apparatuses.

The measuring apparatus receives the positional shift map (data D72) and calculates a correction coefficient for pixel conversion for the respective pixels by the process of loop L80. The process of loop L80 includes a reference pixel calculating step (step S80) and a correction conversion coefficient calculating step (S81).

In the reference pixel calculating step (step S80), the coordinates of pixels on the captured image corresponding to the respective pixels of a pixel arrangement correction image are calculated. Specifically, the positional shift amounts of the respective pixels are read from the positional shift map (data D72) and the corresponding pixels are calculated from the captured image according to the positional shift amounts. The positional shift amount is in sub pixel units and a reference destination coordinate (reference coordinate) is between two pixels arranged in the horizontal direction. In the reference pixel calculating step, the two pixels located around the reference coordinate are determined as reference pixels and the coordinates thereof are calculated.

In the correction conversion coefficient calculating step (step S81), a correction conversion coefficient used when calculating the pixel values used in the pixel arrangement correction image from the pixel values of the two reference pixels is calculated. Specifically, the correction coefficient is determined based on a distance relation between the reference coordinate and the coordinates of the respective reference pixels. The magnitude of the correction coefficient is set to be inversely proportional to the distance between the reference coordinate and the coordinates of the respective reference pixels. That is, the smaller the distance, the larger the correction coefficient, whereas the larger the distance, the smaller the correction coefficient.

By executing the above calculation for all pixels on the pixel arrangement correction image, a pixel arrangement conversion table (data D80) of each pixel is generated. The pixel arrangement conversion table (data D80) is stored in the storage unit 5 of the imaging apparatus 1.

In this manner, by using the pixel arrangement conversion table generating method of the present embodiment, it is possible to get prepared for realizing high-accuracy pixel arrangement conversion corresponding to a sub pixel-based positional shift.

The above-described steps are preparation items performed during an imaging apparatus assembling step.

(Pixel Arrangement Correction Process)

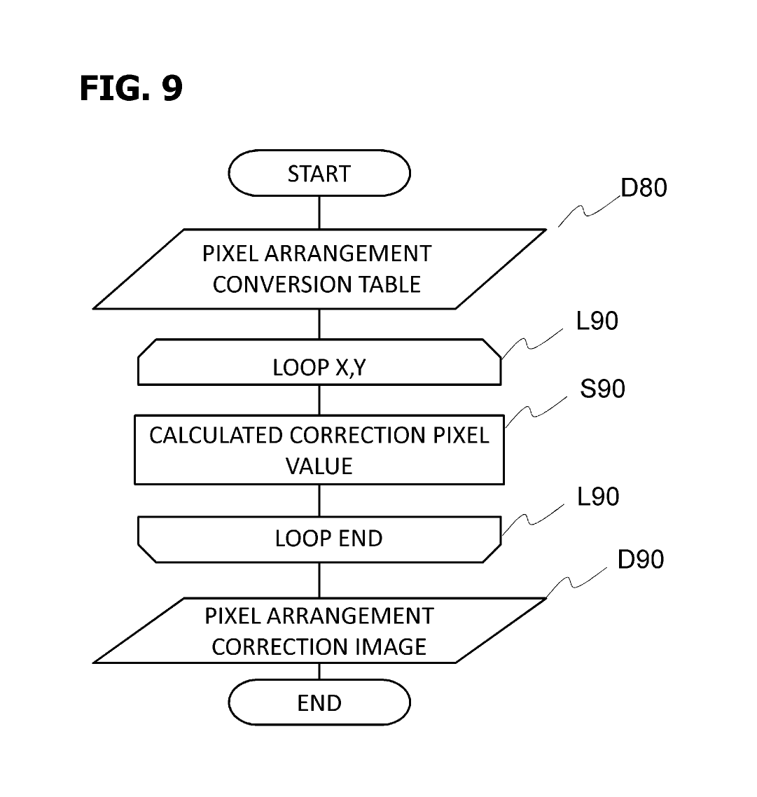

When the captured image is acquired, the processing unit 6 of the imaging apparatus 1 executes an image correction process of correcting a pixel shift caused by shear distortion of the optical fiber bundle 3 using the pixel arrangement conversion table stored in the storage unit 5. Hereinafter, a pixel arrangement correction method will be described with reference to FIG. 9. FIG. 9 is a flowchart of a pixel arrangement correction process executed by the processing unit 6 of the imaging apparatus 1 during or after acquisition of the captured image.

When an image is captured by the imaging apparatus 1, the processing unit 6 reads the pixel arrangement conversion table (data D80) from the storage unit 5. Subsequently, in a correction pixel value calculating step (step S81), the processing unit of the imaging apparatus calculates a corrected pixel value from the captured image based on the pixel arrangement conversion table (data D80). Specifically, a plurality of reference pixel coordinates of the captured image and the correction coefficients are acquired from the pixel arrangement conversion table (data D80), the correction coefficient is multiplied by the pixel value of the reference pixel, the multiplication is repeated by the number of reference pixels, and the multiplication results are added together to calculate a correction pixel value. Here, the correction pixel value Ic is expressed by Expression (3).

$$Ic = {\sum }_{i = 1}^{n} ( {Ir}_{i} \times {k}_{i} ) \qquad ( 3 )$$

Here, Ir is a pixel value of a reference pixel of the captured image, k is a correction coefficient, i is a reference pixel number, and n is the number of reference pixels.

In loop L90, the processing unit 6 of the imaging apparatus 1 can generate the pixel arrangement correction image (data D90) by performing calculation for all pixels.

As described above, the reference coordinates are calculated with accuracy in units of sub pixels and the pixel arrangement is corrected based on the distance between the reference coordinate and the respective pixels. Therefore, it is possible to generate a high-quality pixel arrangement correction image in which lines are connected smoothly and the corrected pixel arrangement is rarely noticeable.

In the present embodiment, in order to eliminate a difference in an optical magnification and a pixel pitch of the microscope 40 and the imaging apparatus 1, the image captured by the microscope 40 is reduced so that the fiber pitch on the image is approximately the same as the pixel pitch of the captured image of the imaging apparatus 1. After that, the pixel-based positional shift amount is measured.

However, a method of eliminating a difference in the optical magnification and the pixel pitch of the microscope 40 and the imaging apparatus 1 is not limited to this. For example, the pixel-based positional shift amount may be measured using the original image captured by the microscope, and the pixel arrangement correction table of the imaging apparatus may be generated using a positional shift map which converts the pixel-based positional shift amount on the microscope to a pixel-based positional shift amount on the imaging apparatus.

FIG. 8B illustrates a flowchart of a pixel arrangement conversion table generating process according to a modification of the present embodiment. This process is executed by the measuring apparatus (computer). In this modification of the present embodiment, the positional shift map (data D72) on the microscope is created by calculating the pixel-based positional shift amount from the original image captured by the microscope according to the process illustrated in the flowchart of FIG. 7.

In a positional shift amount conversion step (step S82), the pixel-based positional shift amount on the microscope 40 is converted to a pixel-based positional shift amount on the imaging apparatus 1. In this example, the ratio of fiber pitches on the images of the microscope 40 and the imaging apparatus 1 is calculated, and the pixel-based positional shift amount on the microscope 40 is divided by the ratio of the fiber pitch on the captured image of the imaging apparatus 1 to convert the pixel-based positional shift amount on the microscope 40 to the pixel-based positional shift amount on the imaging apparatus. In this way, an imaging apparatus positional shift map (data D81) is created.

A method of generating the pixel arrangement conversion table (D80) based on the imaging apparatus positional shift map (data D81) is the same as the flowchart illustrated in FIG. 8A. Moreover, origin matching may be performed for alignment of the imaging apparatus positional shift map (data D81) and the image sensors of the imaging apparatus 1.

According to the present embodiment, a positional shift amount of some optical fibers such as shear distortion occurring in the optical fiber bundle 3 can be measured with high accuracy in units of sub pixels. Moreover, it is possible to create a correction table for correcting image distortion resulting from positional shift of the optical fiber bundle. Therefore, the imaging apparatus which uses an optical fiber bundle can acquire a high-quality image in which image distortion resulting from a positional shift is rarely noticeable.

### Embodiment 2

An imaging apparatus according to Embodiment 2 of the present invention will be described. The imaging apparatus of the present embodiment is different from the imaging apparatus of Embodiment 1 in that pixel-based positional shifts in both horizontal and vertical directions are measured and that a pixel conversion table for correcting the pixel-based positional shifts in both horizontal and vertical directions is generated.

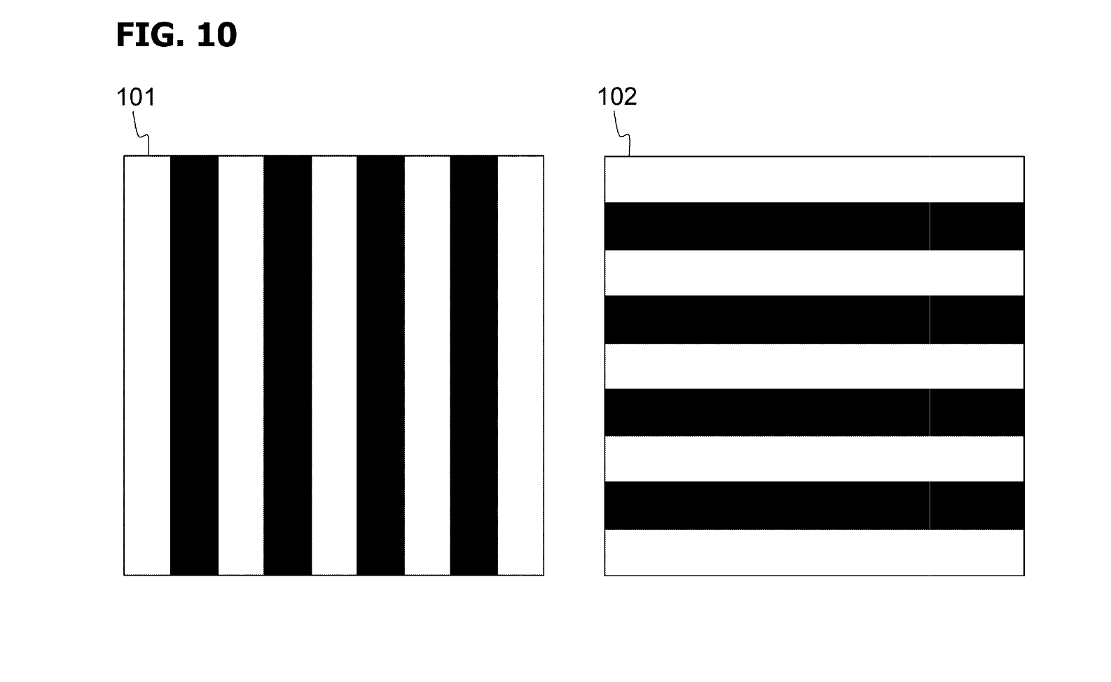

FIG. 10 illustrates a test chart used during measurement of a pixel-based positional shift amount (shear distortion amount) of the present embodiment. In the present embodiment, a vertical stripe chart 101 having a cyclic pattern arranged in the horizontal direction and a horizontal stripe chart 102 having a cyclic pattern arranged in the vertical direction are used. A method of measuring a horizontal pixel-based positional shift using the vertical stripe chart 101 is the same as that of Embodiment 1. In a method of measuring a vertical pixel-based positional shift using the horizontal stripe chart 102, the words “horizontal” and “vertical” are replaced in the method of measuring a horizontal pixel-based positional shift using the vertical stripe chart.

In this manner, by measuring the pixel-based positional shift amounts using the vertical stripe chart 101 and the horizontal stripe chart 102, the horizontal and vertical pixel-based positional shifts can be measured from the phase shifts in the horizontal and vertical directions with high accuracy in units of sub pixels. Moreover a two-dimensional pixel-based positional shift can be acquired based on the horizontal and vertical pixel-based positional shifts.

A pixel arrangement conversion table generating method of the present embodiment will be described with reference to FIG. 8. The pixel arrangement conversion table generation flow of the present embodiment is the same as that of Embodiment 1. However, since the reference destination coordinate has two directions of the horizontal and vertical directions, four pixels around the reference destination coordinates are calculated as the reference pixels in the reference pixel calculating step (step S80). Further, in the correction conversion coefficient calculating step (step S81), the correction conversion coefficient is calculated by determining the magnitude of the correction coefficient based on the distance between the reference destination coordinate and the coordinates of the four pixels. This calculation is repeatedly performed for all pixels to generate the pixel arrangement correction table (data D80), which is stored in the storage unit 5 of the imaging apparatus 1.

When the pixel arrangement on the imaging apparatus 1 is corrected, the processing unit 6 of the imaging apparatus 1 reads the pixel arrangement correction table (data D80) from the storage unit 5 and calculates a correction pixel value from the captured image according to Expression (3) to generate the pixel arrangement correction image (data D90). The number n of reference pixels in Expression (3) is 2 in Embodiment 1, whereas the number n of reference pixels is 4 in the present embodiment.

By employing the above configuration, it is possible to provide a pixel arrangement correction method capable of correcting the horizontal and vertical pixel-based positional shifts with high accuracy and to provide a high-quality pixel arrangement correction image.

In the present embodiment, although both the vertical stripe chart 101 and the horizontal stripe chart 102 are used as the test chart, the test chart used is not limited to this. For example, a chart in which a vertical stripe and a horizontal stripe are multiplexed in one chart may be used. In this case, when different colors are used for the vertical stripe and the horizontal stripe or a sinusoidal wave chart is used, the vertical stripe and the horizontal stripe can be distinguished even if both strips are displayed in one chart. Because of this, the horizontal and vertical pixel-based positional shifts can be detected by single pixel-based positional shift measurement.

### Embodiment 3

An imaging apparatus according to Embodiment 3 of the present invention will be described. The imaging apparatus of the present embodiment is different from the imaging apparatus of Embodiment 2 in that the pixel-based positional shift is measured in three directions.

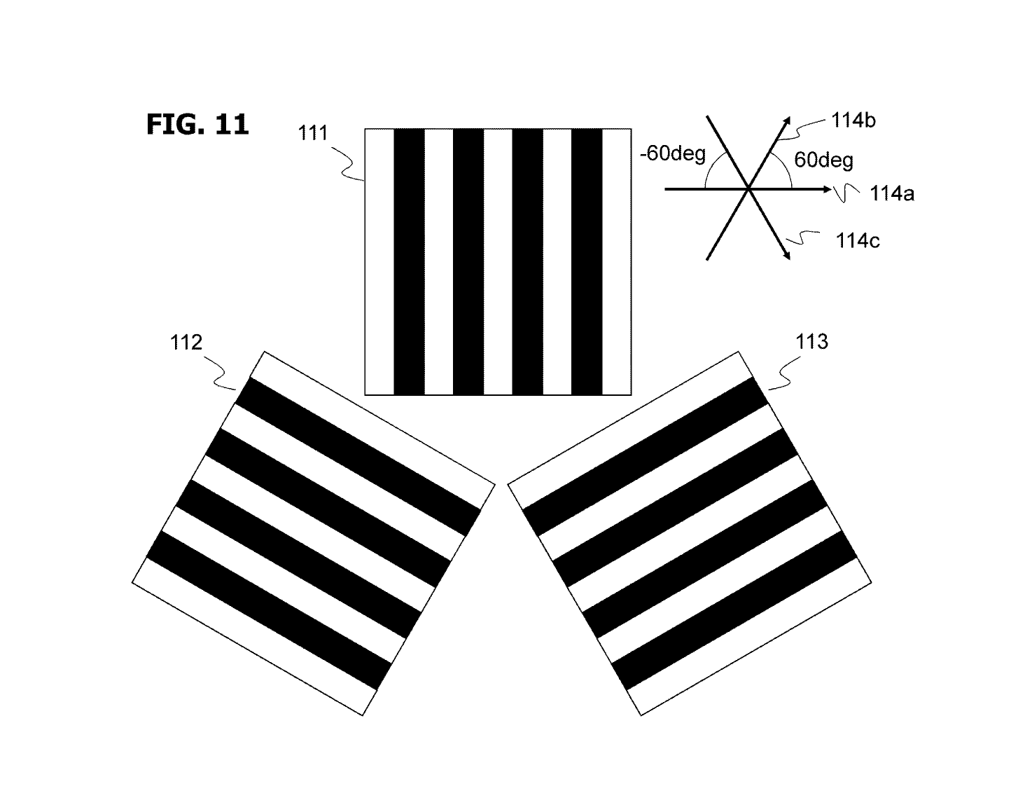

FIG. 11 illustrates an test chart used for measurement of a pixel-based positional shift amount (shear distortion amount) of the present embodiment. In the present embodiment, cyclic patterns arranged in three directions are used. A first pattern is a vertical stripe chart 111 having a cyclic pattern arranged in a horizontal direction 114a. A second pattern is a first oblique stripe chart 112 having a cyclic pattern arranged in a direction 114b rotated +60 deg from the horizontal direction. A third pattern is a second oblique stripe chart 113 having a cyclic pattern arranged in a direction 114c rotated −60 deg from the horizontal direction.

These charts 111, 112, and 113 have the cyclic patterns formed in a direction parallel to one side of a polygon formed by a block that causes shear distortion. In the present embodiment, the six sides of a hexagon formed by the multi-fiber or the multi-multi fiber extend in three directions of the horizontal direction, a direction rotated +60 deg from the horizontal direction, and a direction rotated −60 deg from the horizontal direction. Thus, the test chart has the cyclic patterns formed in these directions.

A method of measuring a horizontal pixel-based positional shift using the vertical stripe chart is the same as that of Embodiment 1. In a method of measuring the pixel-based positional shift in the directions rotated ±60 deg from the horizontal direction using the oblique stripe charts, the pixel-based positional shifts are measured in the directions rotated ±60 deg from the horizontal direction in which the cyclic patterns of the charts appear.

Since shear distortion causes a pixel-based positional shift to occur along the sides of a polygon formed by the multi-fiber or the multi-multi fiber, the pixel-based positional shifts can be detected with highest accuracy when the pixel-based positional shifts are measured using charts having cyclic patterns formed along the directions. The subsequent processes are the same as those of Embodiment 2.

In the present embodiment, although the test chart having three cyclic patterns arranged in three directions is used, practically, the pixel-based positional shift often occurs in one of these directions. Thus, a pixel-based positional shift amount detected in the direction in which the pixel-based positional shift amount is the largest may be used as the pixel-based positional shift amount of the pixel.

### Embodiment 4

An imaging apparatus according to Embodiment 4 of the present invention will be described. The imaging apparatus of the present embodiment is different from the imaging apparatus of Embodiment 1 in that a large pixel-based positional shift in the horizontal direction can be measured.

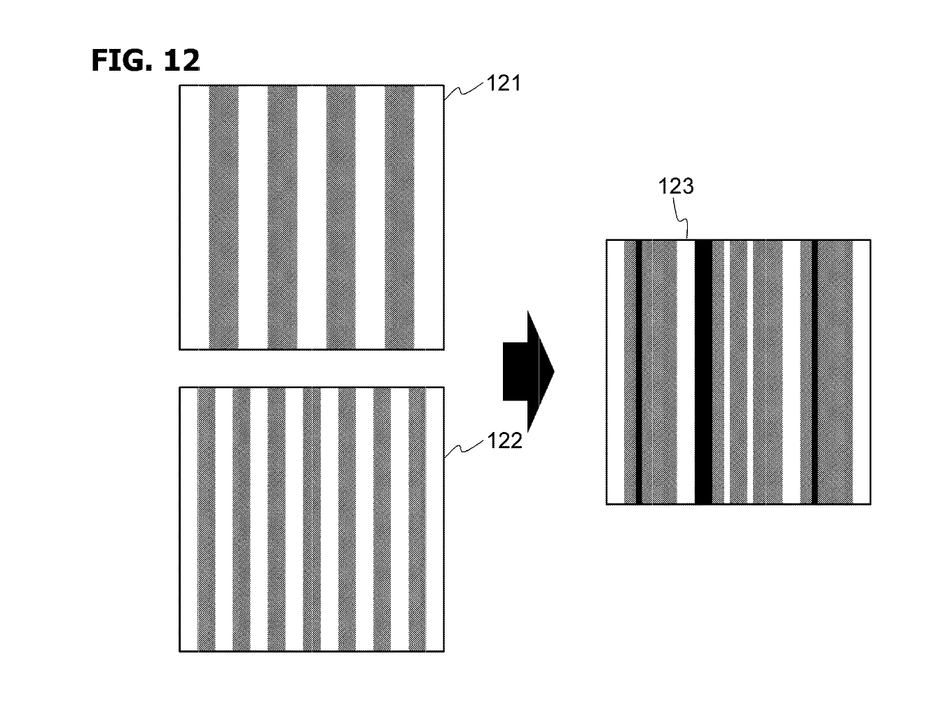

FIG. 12 illustrates a test chart of the present embodiment. In the present embodiment, a combined cyclic pattern 123 having a cyclic pattern in the horizontal direction, obtained by combining a plurality of cyclic patterns 121 and 122 having different cycles is used. For example, a cycle T3 of the combined cyclic pattern 123 obtained by combining the cyclic pattern 121 having a first cycle T1 and the cyclic pattern 122 having a second cycle T2 is the least common multiple of the first and second cycles T1 and T2. Here, it is assumed that the first cycle T1 is larger than the second cycle T2. In this case, the first cycle T1 is not the multiples of the second cycle T2. Because of this, the cycle T3 of the combined cyclic pattern 123 can be set larger than the first cycle T1.

A largest value of a detection range of the pixel-based positional shifts is ±½ of the cycle of the cyclic pattern. Thus, by using a pattern having a large cycle, it is possible to detect a large positional shift. On the other hand, the shorter the cycle of the pattern used, the higher the detection accuracy (resolution) of the pixel-based positional shift.

As in the present embodiment, by using the combined cyclic pattern 123 having the cycle T3 larger than any one of the cycles T1 and T2 of the cyclic patterns before combination, it is possible to increase the detection range of the pixel-based positional shifts. On the other hand, the components of the cyclic patterns 121 and 122 before combination can be detected, and high detection accuracy of the pixel-based positional shift can be maintained by detecting the phase from the components of the cyclic patterns 121 and 122 before combination. That is, a large pixel-based positional shift can be detected from a phase difference of the cycle component of the third cycle T3, and an accurate pixel-based positional shift can be detected from the cycle component of the second cycle T2 (the lower cycle of T1 and T2 or both cycles).

In this manner, in the present embodiment, by using one combined cyclic pattern 123, it is possible to improve the detection accuracy of the pixel-based positional shift and to increase the detection range.

In the present embodiment, although the cyclic pattern arranged in the horizontal direction has been described, the present invention is not limited to this, and for example, a combined cyclic pattern arranged in both horizontal and vertical directions as illustrated in Embodiment 2 may be used. Moreover, the advantages of the present invention can be obtained even when a combined cyclic pattern arranged in the direction along the sides of a polygon formed by the multi-fiber or the multi-multi fiber as illustrated Embodiment 3 is used.

### Embodiment 5

An imaging apparatus according to Embodiment 5 of the present invention will be described. The imaging apparatus of the present embodiment is different from the imaging apparatus of Embodiment 2 in that the optical fiber bundle of the imaging apparatus has a different configuration and that a pixel-based positional shift caused by shear distortion of the optical fiber bundle is measured using an image captured by the imaging apparatus on which the optical fiber bundle is mounted.

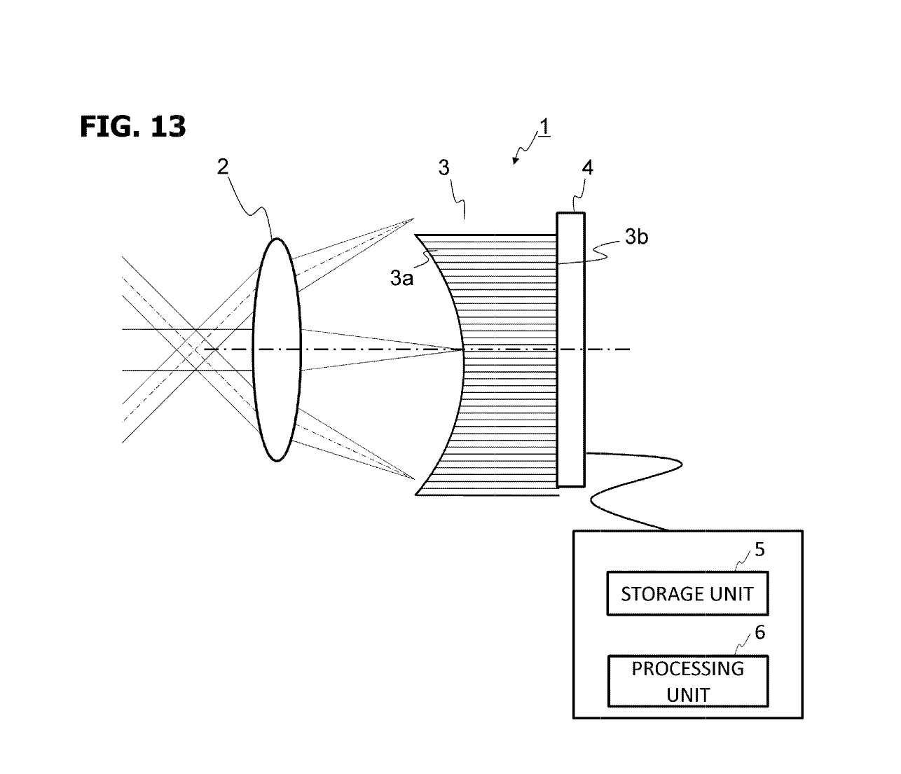

FIG. 13 illustrates an imaging apparatus of the present embodiment. An imaging apparatus 1 of the present embodiment includes an imaging optical system 2, an optical fiber bundle 3, an image sensor 4, a storage unit 5, and a processing unit 6. The imaging optical system 2 of the present embodiment images a subject present on a focusing plane (not illustrated) onto a curved image plane to obtain a subject image. The optical fiber bundle 3 has an incident end surface 3a having a curved shape following the shape of the image plane of the imaging optical system 2. Thus, the incident end surface 3a can receive the image focused on the image plane of the imaging optical system 2 without any blur. Moreover, the optical fiber bundle 3 has an exit end surface 3b which has a planar shape and is in close contact with an imaging surface of the image sensor 4, and the image transmitted from the incident end surface 3a of the optical fiber bundle to the exit end surface 3b is acquired by the image sensor 4.

In the imaging apparatus of the present embodiment, the optical fiber bundle 3 having a curved incident end surface is used to correct the curvature of the image plane of the imaging optical system 2 so that a high-definition image can be captured.

A pixel-based positional shift amount measurement method of the present embodiment will be described. In the present embodiment, a pixel-based positional shift amount is measured using two test charts including vertical and horizontal stripes similarly to Embodiment 2. The test charts used in the present embodiment are the same as the vertical stripe chart 101 and the horizontal stripe chart 102 illustrated in FIG. 10.

First, a horizontal pixel-based positional shift amount is measured using the vertical stripe chart 101 of the vertical stripe having a cyclic pattern in the horizontal direction among the test charts illustrated in FIG. 10. The flowchart of the pixel-based positional shift amount measuring process of the present embodiment is the same as that of FIG. 7.

In a cyclic pattern capturing step (step S71), the vertical stripe chart 101 having a cyclic pattern in the horizontal direction is captured by the imaging apparatus 1 to acquire a captured image. Here, an imaging magnification of the imaging optical system 2 is 1/10, and the cycle of the test chart is set to 40 times of the fiber pitch so that the cycle in the horizontal direction on the incident surface of the optical fiber bundle is approximately 4 times the fiber pitch.

The captured image of the vertical stripe chart 101 is output from the imaging apparatus 1 and is input to an external calculator (not illustrated). The subsequent processes (loop L70 and steps S72 to S76) are executed by the external calculator. The external calculator is a computer having a CPU, a memory, and the like and can execute the processes by causing the CPU to execute application programs stored in the memory.

Subsequently, a vertical pixel-based positional shift amount is measured using the horizontal stripe chart 102 having a cyclic pattern in the vertical direction among the test charts illustrated in FIG. 10. In the cyclic pattern capturing step (step S71), the horizontal stripe chart 102 having the cyclic pattern in the vertical direction is captured by the imaging apparatus 1 to acquire a captured image. The captured image is output from the imaging apparatus 1 and is input to an external calculator (not illustrated). The subsequent processes (loop L70 and steps S72 to S76) are executed by the external calculator.

In this way, measurement of the pixel-based positional shift amount of the captured image in the horizontal and vertical directions is completed.

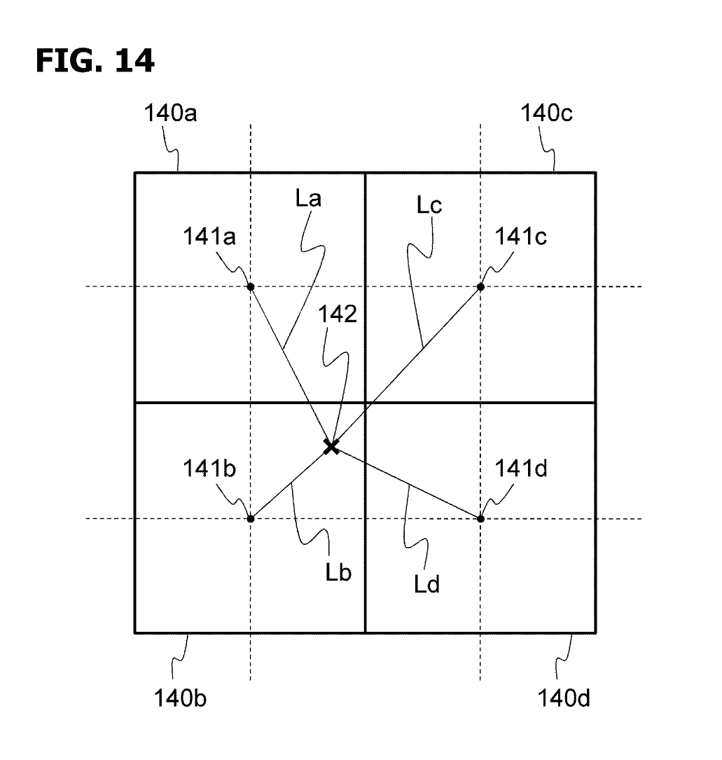

Next, a pixel arrangement conversion table generating process will be described. The flowchart of the pixel arrangement conversion table generating method of the present embodiment is the same as that illustrated in FIG. 8. The pixel arrangement conversion table generating process will be described with reference to FIG. 14. FIG. 14 illustrates pixels of the captured image and the corresponding coordinates.

A pixel-based positional shift amount is read from the positional shift map (data D72) and the corresponding coordinate in the captured image is calculated according to the pixel-based positional shift amount. The pixel-based positional shift amount is in sub pixel units and the corresponding coordinate is between the four pixels 140a, 140b, 140c, and 140d arranged in the horizontal and vertical directions.

In the reference pixel calculating step (step S80), the reference pixel coordinates are calculated using the four pixels 140a, 140b, 140c, and 140d as the reference pixels.

In the correction conversion coefficient calculating step (step S81), a correction coefficient (weighting factor) is determined according to a distance relation between the corresponding coordinate 142 and the four reference pixels 140a, 140b, 140c, and 140d. Here, when the reference pixels 140a, 140b, 140c, and 140d are ka, kb, kc, and kd, respectively, these pixels can be calculated by Expression (4), for example.

$$ka = \frac{1}{La \times T} \\ kb = \frac{1}{Lb \times T} \\ kc = \frac{1}{Lc \times T} \\ kd = \frac{1}{Ld \times T} \qquad ( 4 )$$

Here,

$$T = \frac{1}{La} + \frac{1}{Lb} + \frac{1}{Lc} + \frac{1}{Ld} .$$

In this expression, La is the distance between the corresponding coordinate 142 and the center 141a of the reference pixel 140a, Lb is the distance between the coordinate 142 and the center 141b of the reference pixel 140b, Lc is the distance between the coordinate 142 and the center 141c of the reference pixel 140c, and Ld is the distance between the coordinate 142 and the center 141d of the reference pixel 140d.

In Expression (4), the correction coefficient k is set to be proportional to the distance between the corresponding coordinate 142 and the reference pixels 140a, 140b, 140c, and 140d. As another example, the correction coefficient k may be set to be proportional to the square of the distance between the corresponding coordinate 142 and the reference pixels 140a, 140b, 140c, and 140d, and the relation is expressed in Expression (5).

$$ka = \frac{1}{{La}^{2} \times T} \\ kb = \frac{1}{{Lb}^{2} \times T} \\ kc = \frac{1}{{Lc}^{2} \times T} \\ kd = \frac{1}{{Ld}^{2} \times T} \qquad ( 5 )$$

Here,

$$T = \frac{1}{{La}^{2}} + \frac{1}{{Lb}^{2}} + \frac{1}{{Lc}^{2}} + \frac{1}{{Ld}^{2}} .$$

In this expression, La is the distance between the corresponding coordinate 142 and the center 141a of the reference pixel 140a, Lb is the distance between the coordinate 142 and the center 141b of the reference pixel 140b, Lc is the distance between the coordinate 142 and the center 141c of the reference pixel 140c, and Ld is the distance between the coordinate 142 and the center 141d of the reference pixel 140d.

By executing the reference pixel calculating step (step S80) and the correction conversion coefficient calculating step (step S81) for all pixels of the pixel arrangement correction image, a pixel arrangement conversion table (data D80) of each pixel is generated. The pixel arrangement conversion table (data D80) is stored in the storage unit 5 of the imaging apparatus.

In this manner, by using the pixel arrangement conversion table generating method of the present embodiment, it is possible to realize high-accuracy pixel arrangement conversion corresponding to a sub pixel-based positional shift in two-dimensional directions. The above-described steps are preparation items performed during an imaging apparatus assembling step.

Next, the pixel arrangement correction process performed on the image captured by the imaging apparatus 1 will be described. The flowchart of a pixel arrangement correction process of the present embodiment is the same as that of FIG. 9.

When an image is captured by the imaging apparatus 1, the processing unit 6 reads the pixel arrangement conversion table (data D80) from the storage unit 5. Subsequently, in a correction pixel value calculating step (step S90), the processing unit 6 of the imaging apparatus 1 calculates a corrected pixel value from the captured image based on the pixel arrangement conversion table (data D80). Here, the correction pixel value Ic is calculated by Expression (3).

The processing unit 6 of the imaging apparatus generates the pixel arrangement correction image (data D90) by executing the correction pixel value calculating step (step S90) for all pixels.

As described above, the corresponding coordinate is calculated with accuracy in units of sub pixels and the correction coefficient is determined based on the distance between the corresponding coordinate and the reference image when correcting the pixel arrangement. Therefore, it is possible to generate a high-quality pixel arrangement correction image in which lines of the pixel arrangement correction image are connected smoothly.

### Embodiment 6

An imaging apparatus according to Embodiment 6 of the present invention will be described. The imaging apparatus of the present embodiment is different from the imaging apparatus of Embodiment 5 in that the processing unit 6 of the imaging apparatus includes a calculator that executes all calculating processes.

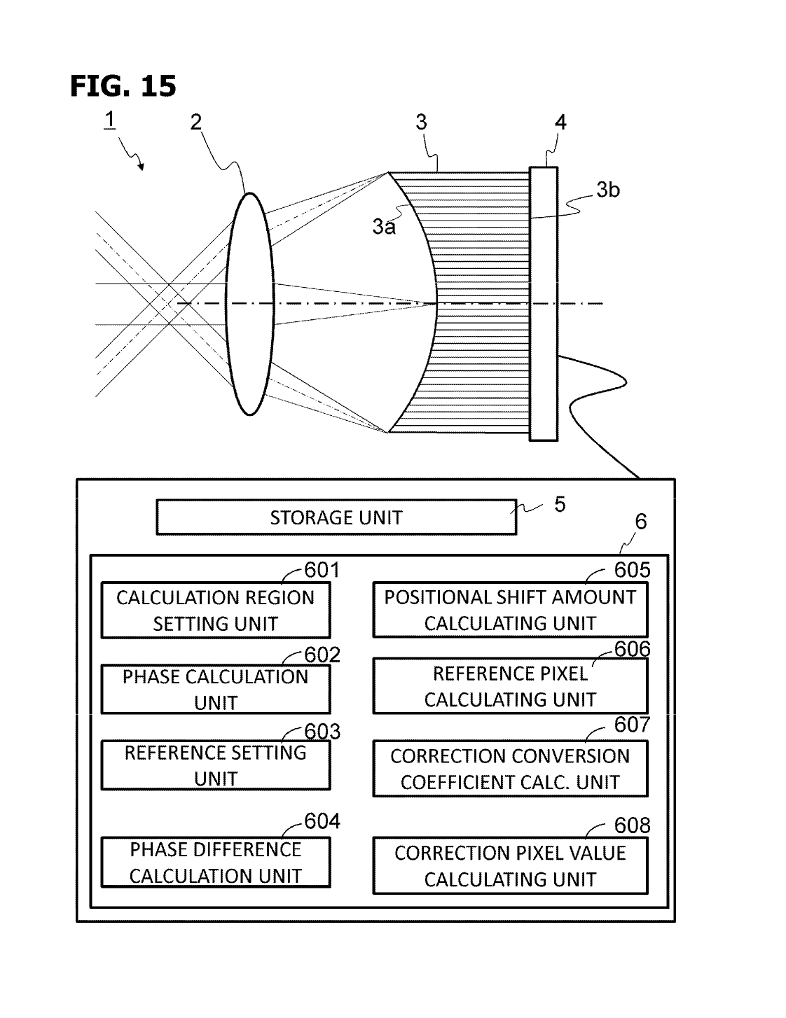

FIG. 15 illustrates an imaging apparatus of the present embodiment. An imaging apparatus 1 of the present embodiment includes an imaging optical system 2, an optical fiber bundle 3, an image sensor 4, a storage unit 5, and a processing unit 6. The processing unit 6 includes a calculation region setting unit 601, a phase calculating unit 602, a reference setting unit 603, a phase difference calculating unit 604, a positional shift amount calculating unit 605, a reference pixel calculating unit 606, a correction conversion coefficient calculating unit 607, a correction pixel value calculating unit 608. These functional units are realized when the processor of the processing unit 6 executes a program.

The flowchart of the pixel-based positional shift amount calculation method of the present embodiment is the same as that of FIG. 7. However, all process steps are performed by the processing unit 6 without using an external calculator. That is, the calculation region setting unit 601 executes the calculation region setting step (step S72). The phase calculating unit 602 executes the phase calculating step (step S73). The reference setting unit 603 executes the reference setting step (step S74). The phase difference calculating unit 604 executes the phase difference calculating step (step S75). The positional shift amount calculating unit 605 executes the positional shift amount calculating step (step S76). With the above processes, the positional shift map is generated.

The flowchart of the pixel arrangement conversion table generating method of the present embodiment is the same as that of FIG. 8. The reference pixel calculating unit 606 executes the reference pixel calculating step (step S80) and the correction conversion coefficient calculating unit 607 executes the correction conversion coefficient calculating step (step S81) to generate the pixel arrangement conversion table.

The flowchart of the pixel arrangement correction image generating method of the present embodiment is the same as that of FIG. 9. The correction pixel value calculating unit 608 executes the correction pixel value calculating step (step S90) to generate the pixel arrangement correction image.

As in the imaging apparatus of the present embodiment, when the imaging apparatus includes processing units for calculating the pixel-based positional shift amount, generating the pixel arrangement conversion table, and generating the pixel arrangement correction image, it is possible to reconstruct the pixel arrangement conversion table any time after the products are shipped. That is, after the products are shipped, even when the positional relation between the optical fiber bundle 3 and the image sensor 4 is shifted, the imaging apparatus can reconstruct the positional relation.

### Embodiment 7

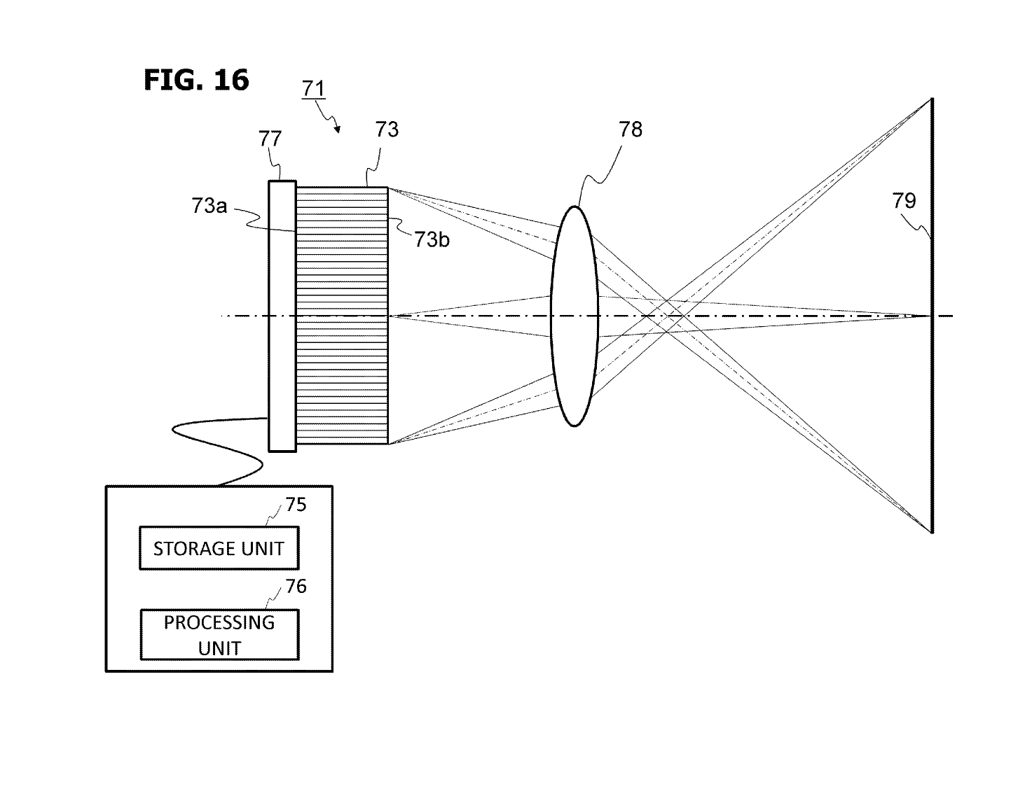

A projecting apparatus according to Embodiment 7 of the present invention will be described. FIG. 16 illustrates a projecting apparatus of the present embodiment. A projecting apparatus 71 includes a storage unit 75, a processing unit 76, a spatial modulator 77 formed of a liquid crystal panel, an optical fiber bundle 73, and a projection optical system 78. The processing unit 76 outputs an image signal to the spatial modulator 77. The spatial modulator 77 displays an image corresponding to the input signal to project the image onto an incident end surface 73a of the optical fiber bundle 73. The optical fiber bundle 73 transmits the image received on the incident end surface 73a to an exit end surface 73b. The projection optical system 78 form the transmission image displayed on the exit end surface 73b of the optical fiber bundle 73 on a screen 79 whereby a projecting apparatus that projects an image from a liquid crystal panel onto a screen is formed.

The optical fiber bundle 73 of the present embodiment has a structure in which a plurality of optical fibers 3a are bound to form small clusters 30b and 30c of optical fiber bundles and a plurality of clusters 3b and 3c of optical fibers are bound similarly to the optical fiber bundle 3 of Embodiment 1. Moreover, a relative positional relation between the incident end surface 73a and the exit end surface 73b, of some or all of the clusters 30b and 30c of optical fibers in relation to the surrounding optical fibers varies. Thus, a pixel-based positional shift occurs between the image received on the incident end surface 73a of the optical fiber bundle 73 and the image transmitted to the exit end surface 73b.

When such an optical fiber bundle 73 is used in the projecting apparatus 71, a pixel-based positional shift amount is measured in advance. The processing unit 76 performs a correction process of shifting a pixel position of an image displayed on a liquid crystal panel which is the spatial modulator 77 by a pixel-based positional shift occurring during transmission through the optical fiber bundle 73. By displaying the corrected image on the spatial modulator 77, it is possible to eliminate a positional shift in the image which has been transmitted through the optical fiber bundle 73 and projected from the projection optical system 78 onto the screen 79.

Therefore, by employing the method of correcting the pixel arrangement of the image displayed on the spatial modulator 77 using the pixel-based positional shift amount measurement method and the pixel arrangement conversion table generating method of the present invention, the advantages of the present invention can be obtained in a projecting apparatus which uses the optical fiber bundle 3.

### Embodiment 8

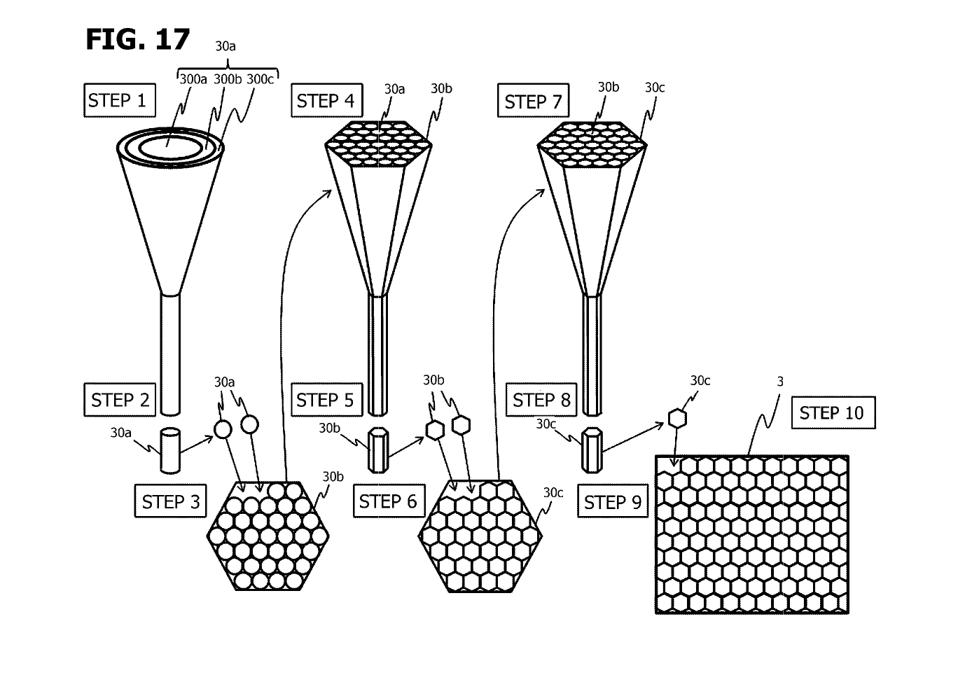

FIG. 17 illustrates the steps of manufacturing an optical fiber bundle. In FIG. 17, Step 1 is a preform heat-stretching step. A preform 30a includes a core layer 300a at a center, a cladding layer 300b around the core layer 300a, and an light absorbing layer 300c around the cladding layer 300b. The preform 30a is heat-stretched to become narrow and thin to obtain an optical fiber 30a. Step 2 is a step of cutting the optical fiber 30a. In Step 2, the narrow and thin optical fiber 30a obtained by heat-stretching the preform is cut to a predetermined length.

Step 3 is an optical fiber stacking step. A plurality of optical fibers 30a cut in Step 2 are arranged to form one-dimensional optical fiber arrays and the one-dimensional optical fiber arrays are stacked to form a two-dimensional optical fiber array. This two-dimensional optical fiber array is the multi-fiber 30b. Step 4 is a step of heat-stretching the multi-fiber 30b. When the multi-fiber 30b is heat-stretched, the diameter of the respective optical fibers 30a of the multi-fiber 30b decreases further. Step 5 is a step of cutting the multi-fiber 30b. In step 5, the narrow and thin multi-fiber 30b is cut to a predetermined length.

Step 6 is a step of stacking the multi-fibers 30b. A plurality of multi-fibers 30b cut in Step 5 are arranged to form one-dimensional multi-fiber arrays and the one-dimensional multi-fiber arrays are stacked to form a two-dimensional multi-fiber array 30c.

This two-dimensional multi-fiber array is the multi-multi fiber 30c. Step 7 is a multi-multi fiber heat-stretching step. The optical fibers 30a that form the heat-stretched multi-multi fiber 30c are finished to a sufficient thinness (for example, 3 μm or 6 μm). Step 8 is a step of cutting the multi-multi fiber 30c. The multi-multi fiber 30c is also cut to a predetermined length.

Step 9 is a step of stacking the multi-multi fibers 30c. A plurality of multi-multi fibers 30c cut in Step 8 are arranged to form one-dimensional multi-multi fiber arrays and the one-dimensional multi-multi fiber arrays are stacked to form a two-dimensional multi-multi fiber array. Step 10 is a step of fixing the two-dimensional multi-multi fibers 30c. The stacked two-dimensional multi-multi fibers 30c are integrated by attaching or welding. In this way, the optical fiber bundle 3 is manufactured.

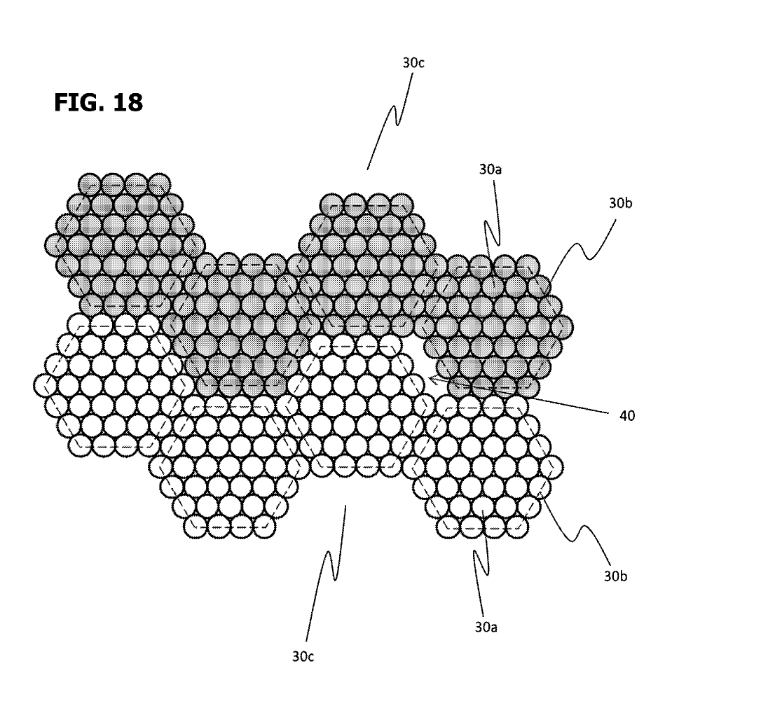

Among these steps, shear distortion is likely to occur in the stacking step (Steps 3, 6, and 9). FIG. 18 illustrates an enlarged view of the boundary between two multi-multi fibers 30c in the multi-multi fiber stacking step. The stacked state will be described with reference to FIG. 18. FIG. 18 illustrates the stacked state of the multi-multi fibers 30c. Two multi-multi fibers 30c are illustrated, and the upper multi-multi fiber 30c is displayed gray and the lower multi-multi fiber 30c is displayed white. FIG. 18 illustrates a state in which the upper multi-multi fiber 30c is stacked on the lower multi-multi fiber 30c with the position of the upper multi-multi fiber 30c aligned accurately.

A plurality of multi-fibers 30b are arranged in the two multi-multi fibers 30c, and a plurality of optical fibers 30a are homogeneously arranged in the multi-fiber 30b. The adjacent multi-fibers 30b are arranged so that optical fibers 30a disposed on the periphery of one multi-fiber 30b are received in the gaps between optical fibers 30a disposed on the periphery of another multi-fiber 30b. By arranging the multi-fibers 30b, the optical fibers 30a can be arranged in a row when seen through a plurality of multi-fibers 30b. This is the state in which the position of the multi-multi fiber is aligned accurately.

The same arrangement is required in the multi-multi fiber stacking step. That is, it is necessary to dispose the optical fibers 30a disposed on the periphery of the upper multi-multi fiber 30c in the gaps between the optical fibers 30a disposed on the periphery of the lower multi-multi fiber 30c. However, with the progress of the multi-fiber heat-stretching step (Step 4) and the multi-multi fiber heat-stretching step (Step 7), the diameter of the optical fibers 30a decreases and the gaps between the optical fibers 30a also decreases. Moreover, since the number of optical fibers 30a included in one unit increases, the number of positions that are to be aligned increases. Thus, with the progress of steps, the stacking requires high positional accuracy. In particular, the steps of stacking the multi-multi fibers 30c requires highest positional accuracy.

The multi-multi fibers 30c cut in the multi-multi fiber cutting step (Step 8) have a considerable length. Thus, when a relative positional relation with the surrounding multi-multi fibers is shifted on both ends of the multi-multi fiber, shear distortion may occur. The shift in the relative positional relation with the surrounding multi-multi fibers occurs since a positional shift occurs during stacking due to rotation, distortion, or bending of the multi-multi fiber 30c.

In the multi-multi fibers 30c illustrated in FIG. 18, since bending occurs on both ends of the multi-multi fiber, a void 40 in which optical fibers 30a are not received is formed between the upper and lower multi-multi fibers 30c. Although the diameter of one optical fiber in the multi-multi fiber 30c is 3.0 μm which is very small, such bending can cause an adverse effect on the quality of a transmission image and can cause shear distortion.

Therefore, in the present embodiment, after the multi-multi fiber stacking step (Step 9), shear distortion of the optical fiber bundle 3 in which the multi-multi fibers 30c are stacked is measured.

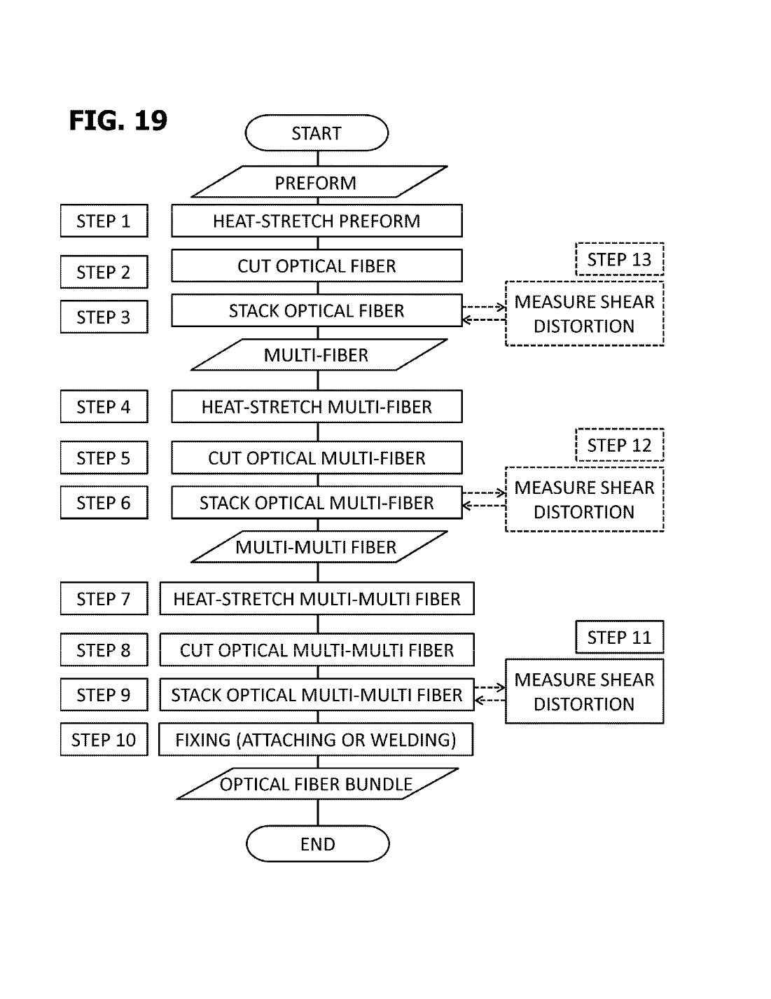

FIG. 19 illustrates the steps of manufacturing the optical fiber bundle 3 of the present embodiment. Although Steps 1 to 9 are the same as the conventional method, a shear distortion measuring step (Step 11) is provided at the end of the multi-multi fiber stacking step (Step 9). With this measurement, shear distortion can be detected before the fixing (attaching or welding) step (Step 10). Therefore, defective multi-multi fibers 30c can be removed and replaced with non-defective multi-multi fibers. Thus, an optical fiber bundle having less shear distortion can be manufactured. In this manner, by incorporating a shear distortion measuring step into the steps of manufacturing the optical fiber bundle 3, it is possible to improve manufacturing quality and to increase the efficiency of manufacturing processes.

In the present embodiment, although the shear distortion measuring step is performed at the end of the multi-multi fiber stacking step (Step 9), the shear distortion may be measured in other steps. For example, as depicted by dot lines in FIG. 19, the shear distortion measuring step (Steps 12 and 13) may be performed at the end of the multi-fiber stacking step (Step 6) and the optical fiber stacking step (Step 3). Because of this, it is possible to further improve manufacturing quality and to further increase the efficiency of manufacturing processes.

Shear distortion may be measured using the method illustrated in Embodiment 1.

When the optical fiber bundle manufactured according to this method is used in the imaging apparatus, it is possible to provide an imaging apparatus capable of capturing high-quality images constantly.

### Other Embodiments

The present invention can be used in products which use an imaging apparatus, such as a digital camera, a digital video camera, a mobile phone camera, a surveillance camera, a medical camera, a wearable camera, an infrared camera, or an X-ray camera. Moreover, the present invention can be used in a projecting apparatus such as a projector or a head-mounted display (HMD).

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-127257, filed on Jun. 20, 2014, and Japanese Patent Application No. 2015-90196, filed on Apr. 27, 2015, which are hereby incorporated by reference herein in their entirety.

1. A positional shift amount measurement method of measuring a positional shift amount of optical fibers in an optical fiber bundle formed by binding a plurality of optical fibers,
the method comprising:
an image acquiring step of capturing an image of a test chart having a cyclic pattern in at least a first direction via the optical fiber bundle to acquire a captured image;
a phase calculating step of calculating phases of respective pixels of the captured image from the cyclic pattern in the captured image; and
a positional shift amount calculating step of calculating a pixel shift amount of the captured image resulting from a positional shift, in the first direction, of the optical fibers in units of sub pixels on the basis of a phase shift of pixels of the captured image arranged in a second direction vertical to the first direction.

2. The positional shift amount measurement method according to claim 1, further comprising:
a reference setting step of setting a partial region of the captured image as a reference region, wherein
the phase calculating step includes calculating a reference cycle in the reference region and calculating a phase of a component corresponding to the reference cycle in the respective pixels of the captured image.

3. The positional shift amount measurement method according to claim 2, wherein
the positional shift amount calculating step includes calculating a difference between a phase of a target pixel and a phase of a pixel, in the reference region, having the same position in the first direction as the target pixel.

4. The positional shift amount measurement method according to claim 1, wherein
the image acquiring step includes capturing an image of a test chart having a cyclic pattern in which a cyclic pattern having a first cycle and a cyclic pattern having a second cycle are combined,
the phase calculating step includes calculating phases of the respective pixels of the captured image with respect to at least one of a component of the first cycle and a component of the second cycle, or a component of a third cycle which is the least common multiple of the first and second cycles, and
the positional shift amount calculating step includes calculating the pixel shift amount, based on at least one of a phase shift of the component of the first cycle and a phase shift of the component of the second cycle, and a phase shift of the component of the third cycle.

5. The positional shift amount measurement method according to claim 1, wherein
the image acquiring step includes capturing the image of the test chart under such imaging conditions according to which each optical fiber in the optical fiber bundle corresponds to one pixel of the captured image.

6. The positional shift amount measurement method according to claim 1, wherein
the image acquiring step includes reducing the captured image so that each optical fiber in the optical fiber bundle corresponds to one pixel of the captured image.

7. The positional shift amount measurement method according to claim 1, wherein
the image acquiring step, the phase calculating step, and the positional shift amount calculating step are performed using a plurality of test charts having cyclic patterns in different directions, and
a two-dimensional pixel shift amount is calculated based on a plurality of pixel shift amounts obtained from the plurality of test charts.

8. The positional shift amount measurement method according to claim 1, wherein
the image acquiring step includes capturing an image of a test chart having a plurality of cyclic patterns in different directions,
the phase calculating step includes calculating phases of respective pixels of the captured image in each of the plurality of directions, and
the positional shift amount calculating step includes calculating a two-dimensional pixel shift amount, based on a phase shift in each of the plurality of directions.

9. The positional shift amount measurement method according to claim 8, wherein
the test chart is obtained by combining a plurality of cyclic patterns arranged in different directions and having different colors.

10. The positional shift amount measurement method according to claim 7, wherein
the optical fiber bundle is obtained by binding a plurality of multi-fibers each obtained by binding a plurality of optical fibers or is obtained by binding a plurality of multi-multi fibers each obtained by binding a plurality of multi-fibers,
the multi-fiber or the multi-multi fiber has a polygonal shape, and
the directions of the cyclic patterns are parallel to each side of the polygon.

11. The positional shift amount measurement method according to claim 1, wherein
the image acquiring step includes acquiring the captured image using an imaging apparatus on which the optical fiber bundle is mounted.

12. A correction table generation method comprising:
the steps of the positional shift amount measurement method according to claim 1; and
a table generating step of generating a correction table for converting an image captured by an imaging apparatus, on which the optical fiber bundle is mounted, into a correction image obtained by correcting a pixel shift in the image, wherein
the table generating step involves:
calculating a sub pixel-based reference coordinate from a pixel shift amount for a target pixel on the correction image;
setting pixels disposed around the reference coordinate on the captured image as reference pixels;
calculating a correction coefficient, based on a distance between the reference coordinate and the reference pixels; and
generating a table in which coordinates of the plurality of reference pixels and correction coefficients of the respective reference pixels are stored for the respective pixels of the correction image.

13. The correction table generation method according to claim 12,
the image acquiring step includes acquiring a captured image of the test chart, captured by an apparatus other than the imaging apparatus,
the positional shift amount calculating step includes converting a pixel shift amount on the captured image acquired in the image acquiring step into a pixel shift amount on the captured image acquired by the imaging apparatus, using a pitch of the optical fibers on the captured image acquired in the image acquiring step and a pitch of the optical fibers on the captured image acquired by the imaging apparatus, and
the table generating step includes generating the correction table, based on the converted pixel shift amount.

14. A correction table generation apparatus that generates a correction table used for correcting an image captured by an imaging apparatus that captures an image via an optical fiber bundle configured by binding a plurality of optical fibers,
the correction table generation apparatus comprising:
an image acquisition unit configured to acquire a captured image of a test chart having a cyclic pattern in at least a first direction, captured via the optical fiber bundle;
a phase calculation unit configured to calculate phases of respective pixels of the captured image from the cyclic pattern in the captured image;
a positional shift amount calculation unit configured to calculate a pixel shift amount of the captured image resulting from a positional shift, in the first direction, of the optical fibers in units of sub pixels on the basis of a phase shift of pixels of the captured image arranged in a second direction vertical to the first direction; and
a table generation unit configured to generate a correction table used for correcting images, and to store for each target pixel coordinates of a plurality of reference pixels determined based on the pixel shift amount and correction coefficients of the respective reference pixels.

15. The correction table generation apparatus according to claim 14, wherein
the image acquisition unit further configured to acquire a captured image of the test chart, captured by the imaging apparatus.

16. The correction table generation apparatus according to claim 14,
the image acquisition unit further configured to acquire a captured image of the test chart, captured by an apparatus other than the imaging apparatus, and
the positional shift amount calculation unit further configured to convert the pixel shift amount on the captured image acquired by the image acquisition unit into a pixel shift amount on the captured image acquired by the imaging apparatus, using a pitch of the optical fibers on the captured image acquired by the image acquisition unit and a pitch of the optical fibers on the captured image acquired by the imaging apparatus.

17. An imaging apparatus comprising an imaging optical system, an optical fiber bundle, an image sensor, a storage unit, and a processing unit,
the imaging optical system forming an image of a subject on an incident end surface of the optical fiber bundle, and
the image sensor acquiring an image exiting from an exit end surface after being transmitted through the optical fiber bundle and storing the image in the storage unit, wherein the optical fiber bundle has a structure which is obtained by binding a plurality of multi-fibers each obtained by binding a plurality of optical fibers or a structure which is obtained by binding a plurality of multi-multi fibers each obtained by binding a plurality of multi-fibers, and in which a relative positional relation between the incident end surface and the exit end surface, of part or all of the multi-fibers or the multi-multi fibers varies in comparison with surrounding optical fibers, and a pixel shift occurs between the image received on the incident end surface of the optical fiber bundle and the image transmitted to the exit end surface,
the storage unit stores a correction table for correcting the pixel shift, and
the processing unit performs a correction process on the image obtained from the image sensor, using the correction table.

18. The imaging apparatus according to claim 17, wherein the correction table is generated according to a correction table generation method including:
calculating a sub pixel-based reference coordinate from a pixel shift amount for a target pixel on the correction image;
setting pixels disposed around the reference coordinate on the acquired image as reference pixels;
calculating a correction coefficient, based on a distance between the reference coordinate and the reference pixels; and
generating a table in which coordinates of the plurality of reference pixels and correction coefficients of the respective reference pixels are stored for the respective pixels of the correction image.
